(19) United States
(12) Patent Application Publication
(10) Pub. No.: US 2009/0032602 A1
(43) Pub. Date: Feb. 5, 2009

(54) THERMOBONDABLE POLYESTER FILM, PROCESS FOR PRODUCTION OF IC CARDS OR IC TAGS WITH THE SAME, AND IC CARDS WITH IC TAGS

(75) Inventors: Mutsuo Nishi, Fukui (JP); Yasushi Sasaki, Fukui (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: TOYO BOSEKI KABUSHIKI KAISHA, Osaka-shi, Osaka (JP)

(21) Appl. No.: 11/912,810

(22) PCT Filed: Apr. 28, 2006
(86) PCT No.: PCT/JP2006/308999

§ 371 Date: Nov. 27, 2007

(30) Foreign Application Priority Data
Apr. 28, 2005 (JP) 2005-131373
Apr. 28, 2005 (JP) 2005-131376

(51) Int. Cl. B32B 7/12; G06K 19/02

(52) U.S. Cl. 235/488; 428/339; 428/214; 428/317.3; 428/141; 156/306.6

(57) ABSTRACT

[Summary] [Problem] Provision of a thermoadhesive polyester film having improved thermal adhesiveness and ruggedness absorbability and sliding quality while maintaining environmental suitability (halogen-free), heat resistance, and chemical resistance as a plastic material that constitutes IC cards or IC tags. [Solving Means] A thermoadhesive polyester film wherein a thermoadhesive layer is laminated on one face or both faces of a biaxially stretched polyester film, the thermoadhesive layer having a thickness of 5 to 30 μm, consisting of a mixture of a non-crystalline polyester resin A having a glass transition temperature of 50 to 95° C. and a thermoplastic resin B incompatible therewith, the thermoplastic resin B being any of
(a) a crystalline resin having a melting point of 50 to 180° C.,
(b) a non-crystalline resin having a glass transition temperature of −50 to 150° C., and (c) a mixture thereof, and contained at 1 to 30% by mass in the thermoadhesive layer.

### TECHNICAL FIELD

The present invention relates to a thermoadhesive polyester film suitable as a constituent material for IC cards or IC tags, a method of producing IC cards or IC tags using the same, and IC cards or IC tags.

### BACKGROUND ART

In recent years, information management and operation systems using cards or tags incorporating IC chips have been spreading. The cards and tags used for this purpose are generally called “IC cards” and “IC tags”, and are finding applications in a variety of fields where various pieces of information on persons and articles are managed and operated because they are useful in that greater amounts of information can be recorded and retained than do conventional cards, tags and the like of the printing/writing type or the magnetic recording type.

Conventionally, polyvinyl chloride (PVC) has been the mainstream of plastic materials that constitute IC cards or IC tags. However, in recent years, there has been an increased demand for substitution with halogen-free materials from the market because of environmental issues; polyester-series resins have become the mainstream of card materials. As sheets or films consisting of a polyester-series resin, non-oriented sheets consisting of a copolymer polyester comprising 1,4-cyclohexane dimethanol as a copolymer ingredient (PETG), because of non-crystallinity and a processing characteristic similar to that of PVC, or biaxially stretched polyethylene terephthalate (PET) films, because of versatility, are mainly used. However, these currently available sheets and films pose respective problems that are difficult to solve.

For example, in the case of non-oriented PETG sheets, the heat resistance is insufficient. This is because the sheet softens and deforms rapidly nearly at the glass transition temperature when heated because the molecular chain of the polyester that constitutes the sheet has not been stretched and oriented. For this reason, if an IC card or an IC tag is left in an automobile dashboard and the like under the scorching heat of the sun for a long time, if a clothing with an IC card or an IC tag in a pocket thereof is erroneously washed and dried with hot air, and if an IC card or an IC tag is exported to a tropical region in the hold of a cargo ship and the like, the IC card or the IC tag sometimes undergoes dimensional changes, deformation, curls, layer detachment and the like due to heat to damage the appearance or function.

To improve this heat resistance, in recent years, a non-oriented sheet comprising PETG supplemented with polycarbonate and the like has sometimes been used. However, this sheet has slightly poor chemical resistance; when a solvent-based adhesive or a solvent-based ink is used during production of IC cards or IC tags, deformation or discoloration sometimes occurs, posing the problem of damaging the appearance or function.

On the other hand, biaxially stretched PET films are excellent in terms of chemical resistance and heat resistance. However, because biaxially stretched PET films have high elastic modulus values and are unlikely to deform, they are unable to absorb the ruggedness resulting from inside structures (IC chips, circuits and the like) of IC cards or IC tags, posing the problem that the shape of the chip or circuit appears on the surface of the IC card or the IC tag. If such ruggedness is present on the surface of an IC card or an IC tag, the appearance is of course unbeautiful, and the appearance or function is sometimes damaged; for example, prints are blurred due to friction with other articles during transportation, and the surface layer detaches when the IC card or IC tag is caught by other articles.

Biaxially stretched PET films do not have self-adhesiveness as do PVC sheets and PETG sheets, and cannot be adhered by hot pressing or hot lamination. For this reason, in producing an IC card or an IC tag by laminating biaxially stretched PET films, it is unavoidable to process the films after inserting a hot melt adhesive and the like therebetween. Hence, the step for forming an IC card or an IC tag using biaxially oriented films is complex, posing a problem of worse workability and yield.

To mutually compensate for the shortcomings of these materials, a method comprising pasting together a biaxially stretched PET film and a non-oriented PETG sheet has been proposed. However, to paste them together, it is necessary to use a hot melt adhesive; the above-described problem remains unresolved. Generally in non-oriented PETG sheets, it is difficult to produce a thin sheet at high accuracy. Usually, non-oriented PETG sheets available in the market have a thickness exceeding 100 μm. For this reason, non-oriented PETG sheets account for a large percentage of the thickness that constitutes the IC card or the IC tag. Hence, even if non-oriented PETG sheets are configured to be pasted together as described above, the heat resistance is not improved sufficiently for the entire card. Furthermore, a step for pasting together a plurality of films or sheets is required. Hence, the manufacturing process becomes complex, and this is undesirable in terms of quality stability and manufacturing costs.

The present invention proposes a thermoadhesive polyester film having a configuration wherein a particular thermoadhesive resin layer is laminated on one face or both faces of a biaxially stretched polyester film, and having a better balance of heat resistance, chemical resistance, ruggedness absorbability, and thermal adhesiveness than the conventional method comprising pasting together a biaxially stretched PET film and a non-oriented PETG sheet.

As films having a layer configuration similar to that of the present invention, thermoadhesive polyester films mainly for use in packaging materials have been used conventionally. For example, inventions relating to the following thermoadhesive polyester films are disclosed.

(1) Films for heat-insulating packaging materials consisting of a configuration wherein a polybutylene terephthalate/polytetramethylene oxide copolymer is laminated on the surface of a hollow-containing polyester film (see, for example, patent document 1)

(2) Films for packaging materials or electrical insulation consisting of a configuration wherein a mixture of a crystalline polyester and a copolymer polyester of low crystallinity is laminated on the surface of a polyester film (see, for example, patent document 2)

(3) Films for packaging materials consisting of a mixed resin of two kinds of copolymer polyester resins laminated on the surface of a polyester film (see, for example, patent documents 3 and 4)

(4) Films for packaging materials or printing materials wherein a mixed resin of at least one kind of copolymer polyester resin is coated on the surface of a hollow-containing polyester film (see, for example, patent documents 5 and 6)

(5) Films for metal plate laminates or packaging materials wherein a mixture of a copolymer polyester resin and silica particles is laminated on the surface of a polyester film (see, for example, patent documents 7 to 10)

(6) Films for condensers wherein a mixture of a copolymer polyester resin or a copolymer urethane resin and silica particles, calcium carbonate particles, zeolite particles and the like is coated on the surface of a polyester film (see, for example, patent documents 11 to 14)

[Patent document 1] JP-A-SHO-56-4564

[Patent document 2] JP-A-SHO-58-12153

[Patent document 3] JP-A-HEI-1-237138

[Patent document 4] JP-B-3484695

[Patent document 5] JP-B-3314814

[Patent document 6] JP-B-3314816

[Patent document 7] JP-A-HEI-7-132580

[Patent document 8] JP-A-2001-293832

[Patent document 9] JP-A-2004-188622

[Patent document 10] JP-A-2004-203905

[Patent document 11] JP-A-2000-30969

[Patent document 12] JP-A-2001-307945

[Patent document 13] JP-A-2002-79637

[Patent document 14] JP-A-2003-142332

Although these inventions have similar configurations, none of them satisfy the requirement for ruggedness absorbability, a problem to be solved by the thermoadhesive polyester film of the present invention. That is, in the inventions wherein a crystalline copolymer polyester is used as the major constituent of the thermoadhesive layer (patent documents 2, 7 to 10), the deformation of the thermoadhesive layer is insufficient. Hence, the ruggedness absorbability necessary for use as the core sheet for an IC card or an IC tag is insufficient. On the other hand, in the inventions wherein the thermoadhesive layer is provided by a coating method (patent documents 5, 6, 11 to 14), the ruggedness absorbability necessary for use as the core sheet for an IC card or an IC tag is insufficient because the thickness of the thermoadhesive layer is thin. On the other hand, in the inventions using a non-crystalline copolymer polyester as the major constituent of the thermoadhesive layer (patent documents 1, 3, 4), ruggedness absorbability is improved by increasing the thickness of the thermoadhesive layer. However, as the thickness of the thermoadhesive layer increases, the sliding quality of the film worsens, and the sliding quality needed in handling ordinary films is not obtained. Furthermore, if the thickness of the thermoadhesive layer is increased, curls are likely to occur just after production, after storage, and when the film is heat-treated in the after-processing step because the substrate and the thermoadhesive layer have different compositions. Hence, special attention is required for controlling the curls (flatness) of the film. However, in the technical scopes described in the aforementioned patent documents, curls cannot stably be controlled.

Hence, by the conventional technology, it has been difficult to reconcile thermal adhesiveness and ruggedness absorbability and sliding quality. The technical reasons therefor can be considered as follows:

Usually, when ruggedness is to be absorbed by resin deformation, it is advantageous to use a non-crystalline resin. From the viewpoint of thermal adhesiveness, it is advantageous to use a resin having an appropriately low degree of crystallization and a low softening temperature.

However, it is known that when a biaxially stretched film is produced using such a resin, it is difficult to obtain sliding quality. That is, even when using a method in common use for improving the sliding quality of films, comprising containing inorganic particles or organic particles measuring not more than several micrometers in the film, no sufficient ruggedness is obtained on the surface of the film, in the case of biaxially stretched films prepared with a non-crystalline resin as the raw material for the film. Hence, the sliding quality of the film is insufficient.

Although the cause thereof remains unclear, a resin of low crystallinity becomes substantially near-molten in the thermal fixation treatment step for the stretched film. It is conjectured that at this time, a surface tension is exerted to reduce the film surface ruggedness and hence to reduce the surface area, i.e., surface free energy, resulting in the embedding of the particles in the resin.

If particles of large particle diameters are used to improve the sliding quality, high projections resulting from the large particles produce contact failures in some regions of the base portion of the film, sometimes hampering the obtainment of sufficient thermal adhesiveness. Furthermore, in the film manufacturing step or processing step, large particles sometimes drop off and contaminate the manufacturing step, or sometimes reduce the strength of the film or sheet.

In contrast, in non-oriented sheets represented by non-oriented PETG sheets, by embossing the sheet per se, it is possible to form macroscopic ruggedness and obtain sliding quality. However, when a biaxially stretched polyester film having excellent chemical resistance and heat resistance is used as in the present invention, embossing itself is difficult because the film has rigidity, and it has been impossible to use the same method as that for non-oriented sheets.

### DISCLOSURE OF THE INVENTION

### Problems to be Solved by the Invention

It is an object of the present invention to provide a thermoadhesive polyester film having improved thermal adhesiveness and ruggedness absorbability and sliding quality while maintaining environmental suitability (halogen-free), heat resistance, and chemical resistance as a plastic material that constitutes IC cards or IC tags. In addition to the above-described object, the present invention provides a thermoadhesive polyester film showing decreased curls and excellent flatness.

### Means for Solving the Problems

Being capable of solving the aforementioned problems, a first aspect in the present invention is a thermoadhesive polyester film wherein a thermoadhesive layer is laminated on one face or both faces of a biaxially stretched polyester film, the thermoadhesive layer having a thickness of 5 to 30 μm, consisting of a mixture of a non-crystalline polyester resin A having a glass transition temperature of 50 to 95° C. and a thermoplastic resin B incompatible therewith, the thermoplastic resin B being any of (a) a crystalline resin having a melting point of 50 to 180° C., (b) a non-crystalline resin having a glass transition temperature of −50 to 150° C., and (c) a mixture thereof, and contained at 1 to 30% by mass in the thermoadhesive layer.

A second aspect is the thermoadhesive polyester film described in the first aspect, wherein the biaxially stretched polyester film is a white polyester film comprising one or both of a white pigment and fine hollows therein.

A third aspect is the thermoadhesive polyester film described in the first aspect, wherein a thermoadhesive layer is laminated on both faces of the biaxially stretched polyester film, one thermoadhesive layer is designated as the thermoadhesive layer a, and the other designated as the thermoadhesive layer b (as thick as the thermoadhesive layer a or thinner than the thermoadhesive layer a), the ratio of the thicknesses of the thermoadhesive layers (thickness of the thermoadhesive layer a/thickness of the thermoadhesive layer b) is 1.0 to 2.0, and the curl value after heat treatment of the film (110° C., non-loaded, for 30 minutes) is not more than 5 mm.

A fourth aspect is the thermoadhesive polyester film described in the first or second aspect, wherein a large number of fine hollows are present in the film, (a) the apparent density of the film is 0.7 to 1.3 g/cm³, (b) the thickness is 50 to 350 μm, (c) and the optical density is 0.5 to 3.0 or the light transmittance is 25 to 98%.

A fifth aspect is the thermoadhesive polyester film described in the first aspect, wherein the surface of the thermoadhesive layer satisfies the following formulas (1) to (3):

1.0≦St1≦10.0 (1)

3.0≦St1/Sa1≦20 (2)

0.001≦St2≦3.000 (3)

wherein Sa1 means the arithmetic mean surface roughness of the thermoadhesive layer surface, St1 means the maximum height, St2 means the arithmetic mean surface roughness of the surface of the thermoadhesive layer after the film is sandwiched between two clean glass plates having an arithmetic mean surface roughness of not more than 0.001 μm, and subjected to hot press treatment at a temperature of 100° C. and a pressure of 1 MPa for 1 minute, and for all of Sa1, St1, and St2, the unit of measurement is μm.

A sixth aspect is the thermoadhesive polyester film described in the first aspect, wherein the coefficient of static friction between the top surface and back face of the thermoadhesive polyester film is 0.1 to 0.8, and the shaping quality by hot pressing satisfies (4) and (5):

(4) Shaping rate: 40 to 105%

(5) Gradient of outer margin of shaping portion: 20 to 1000%

wherein the shaping rate refers to the depth of the depression in the thermoadhesive layer caused by an antenna circuit or a copper foil piece, when it is placed on the surface of the thermoadhesive layer, hot pressed and removed at normal temperature and normal pressure; the gradient of the outer margin of the shaping portion refers to the gradient of the wall face in the outer margin of this depression.

A seventh aspect is a method of producing IC cards or IC tags, comprising using a core sheet prepared by arranging the thermoadhesive film described in the first aspect on one face or both faces of an inlet provided with an antenna circuit and an IC chip, and pasting the inlet to a plastic film by hot pressing via the thermoadhesive layer of the thermoadhesive film, as a constituent thereof.

An eighth aspect is an IC card or IC tag comprising a core sheet prepared by laminating the thermoadhesive film described in the first aspect on one face or both faces of an inlet provided with an antenna circuit and an IC chip, and pasting the inlet to a plastic film via the thermoadhesive layer of the thermoadhesive film, as a constituent thereof.

A ninth aspect is the IC card or IC tag described in the eighth aspect, wherein a polyester sheet or a biaxially stretched polyester film is laminated on both faces of the core sheet.

A tenth aspect is the IC card or IC tag described in the eighth or ninth aspect, wherein the apparent density of the film is not less than 0.7 g/cm³ and less than 1.3 g/cm³.

An eleventh aspect is the IC card or IC tag described in the eighth or ninth aspect, wherein the light transmittance is not less than 10% and not more than 98%.

A twelfth aspect is the IC card or IC tag described in the eighth or ninth aspect, wherein the light transmittance is not less than 0.01% and not more than 5%.

### EFFECT OF THE INVENTION

The thermoadhesive polyester film of the present invention is capable of achieving mutually conflicting characteristics that have not been achieved in conventional materials or thermoadhesive films for IC cards, such as (a) ruggedness absorbability and environmental suitability (halogen-free), heat resistance, chemical resistance, (b) ruggedness absorbability and thermal adhesiveness, and (c) thermal adhesiveness and sliding quality or flatness (curl reduction).

### (Configurations and Actions/Effects)

Because the thermoadhesive polyester film of the present invention incorporates a biaxially stretched polyester film as the substrate, it is excellent in environmental suitability (halogen-free), heat resistance, and chemical resistance when used in IC cards or IC tags.

Because the thermoadhesive polyester film of the present invention has a particular thermoadhesive layer of appropriate thickness made of a mixture of a non-crystalline polyester resin and a thermoplastic resin incompatible therewith on one face or both faces of a biaxially stretched polyester film, it is excellent in thermal adhesiveness and ruggedness absorbability when used in the core sheet of an IC card or an IC tag.

The thermoadhesive polyester film of the present invention has the thickness of the thermoadhesive layer thereof adjusted in a particular range, and has a structure wherein the molecular chain thereof is stretched and oriented despite the fact that it is a non-crystalline polyester resin. Hence, the thermal deformation of the IC card or IC tag after processing can be improved to the extent of the absence of problems in practical use.

Because the thermoadhesive polyester film of the present invention comprises a particular thermoplastic resin incompatible with a particular polyester in the thermoadhesive layer thereof, and is capable of controlling the surface tension (surface free energy) and surface roughness (surface projections) of the film surface in an appropriate state, the necessary handlability, i.e., sliding quality, can be obtained, from the production to use of the film.

In the thermoadhesive layer, the projections formed by the thermoplastic resin, even when they are large projections, seldom drop off, and are unlikely to cause process contamination. Even at low hot press temperatures, the projections soften and deform to flatten during thermal adhesion, and therefore do not produce thermal adhesiveness reductions like those produced when conventional inorganic or organic particles of large particle diameters are added. Because the likelihood of deformation is greater than that with inorganic or organic particles, there is little concern about the occurrence of film strength reductions.

Furthermore, in the cards and tags produced using the thermoadhesive polyester film of the present invention, the electrical parts and circuits needed for configuring the IC card or IC tag can be surely enclosed. This is because the present invention has a thermoadhesive layer that softens and deforms appropriately during hot press processing, and also because a polymer having a melting point or glass transition temperature that does not interfere therewith is contained as an island ingredient (particulate dispersion) in the thermoadhesive layer. Therefore, the thermoadhesive polyester film of the present invention has shaping quality for surely absorbing the ruggedness in IC chips, metal foil circuits and the like while maintaining sliding quality.

In the thermoadhesive polyester film of the present invention, the flatness needed for use as a constituent material for IC cards or IC tags can be obtained. This is because curls produced in the after-processing step and the like are reduced by adjusting the thickness of the thermoadhesive layer and the thickness of the substrate film, and controlling the thermal shrinkage rate or the coefficient of linear expansion on the top and back faces of the film in appropriate ranges.

In the thermoadhesive polyester film of the present invention, by a commonly known technology for producing a hollow-containing polyester film, a large number of fine hollows can be contained in the film. This is a technology that has been difficult to achieve using conventional PVC or PETG sheets. Thereby, the apparent density, i.e., hollow content, of the thermoadhesive polyester film can be regulated in an appropriate range.

Containing fine hollows in the film appropriately is effective for conferring lightness, flexibility, cushion quality, and writing quality to IC cards or IC tags. IC cards or IC tags prepared using a hollow-containing polyester film as the material do not sink immediately even if dropped in water or in sea. Hence, the accidental loss of IC cards or IC tags can be avoided in many cases. Hollow-containing polyester films have a lower apparent dielectric constant than that of polyester films or sheets that do not contain hollows. Hence, the dielectric loss is small in communications with high-frequency waves in the HF band to the SHF band. That is, IC cards or IC tags prepared using a hollow-containing polyester film as the material have high gain, and are therefore effective in terms of communication accuracy, communication distances, and saving electric power consumption.

Generally, in IC cards or IC tags, for which practical applicability is important, ones of low light transmittance and high hiding quality are preferable from the viewpoint of printing clarity and security. However, in intended uses wherein fashion quality or event quality is needed, transparent ones that passively show the electrical circuit and the like therein are sometimes preferably used. In that case, a transparent biaxially stretched polyester is used as the substrate for the thermoadhesive polyester film. In the present invention, by configuring the thermoadhesive layer with a mixture of a non-crystalline polyester resin and a non-crystalline thermoplastic resin incompatible therewith, the transparency of the thermoadhesive layer is improved. This is because the thermoadhesive layer does not contain a crystalline resin ingredient having optical anisotropy and a high refractive index.

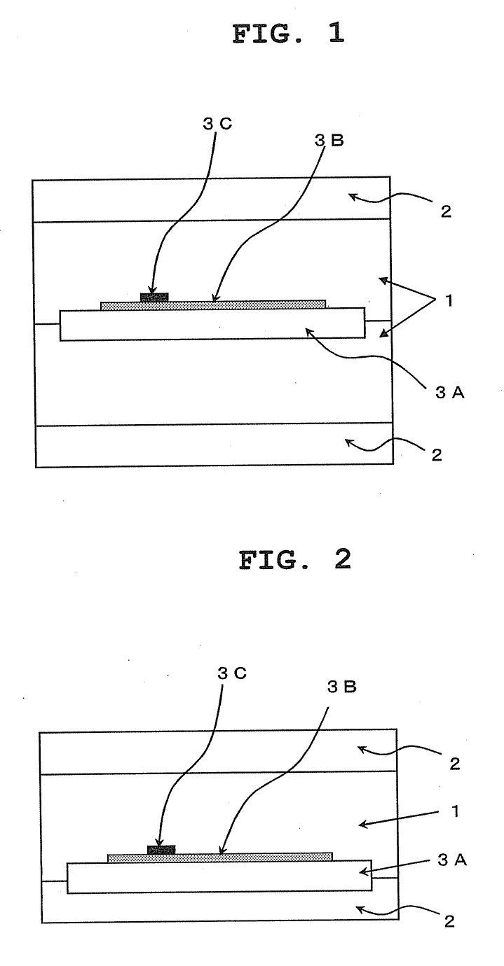

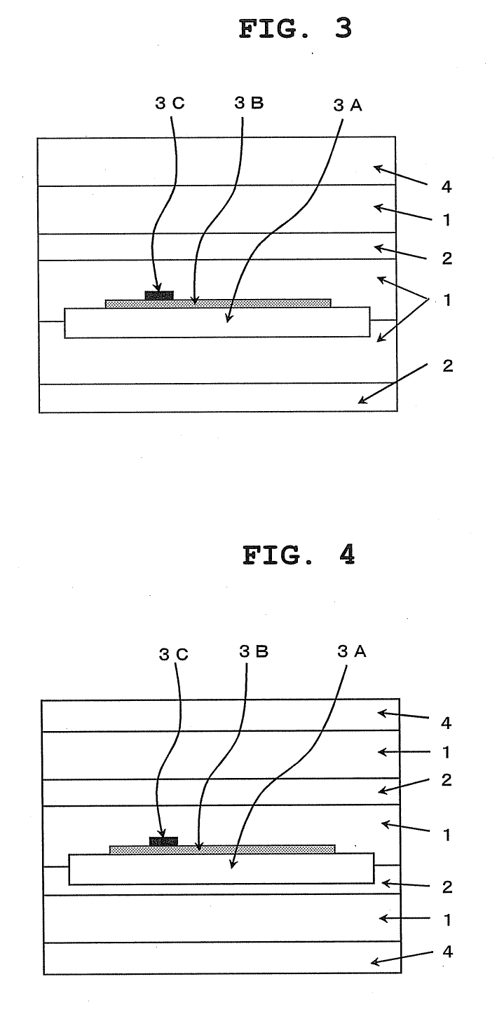

### BRIEF DESCRIPTION OF THE DRAWINGS

[FIG. 1] A schematic diagram of a cross-section of the core sheet used in the IC card obtained in Example 1 of the present invention.

[FIG. 2] A schematic diagram of a cross-section of the core sheet used in the IC card or IC tag of another embodiment of the present invention.

[FIG. 3] A schematic diagram of a cross-section of an IC card or IC tag of the present invention.

[FIG. 4] A schematic diagram of a cross-section of the IC card or IC tag of another embodiment of the present invention.

### EXPLANATION FOR SYMBOLS

1: thermoadhesive layer
2: biaxially stretched polyester film
3: inlet (3A+3B+3C)
3A: plastic film (substrate)
3B: antenna circuit
3C: IC chip
4: non-oriented polyester sheet or biaxially stretched polyester film

### BEST MODE FOR CARRYING OUT THE INVENTION

The thermoadhesive polyester film of the present invention is a thermoadhesive polyester film wherein a thermoadhesive layer is laminated on one face or both faces of a biaxially stretched polyester film, the thermoadhesive layer has a thickness of 5 to 30 μm, comprising a mixture of a non-crystalline polyester resin A having a glass transition temperature of 50 to 95° C. and a thermoplastic resin B incompatible therewith, the thermoplastic resin B is any of (a) a crystalline resin having a melting point of 50 to 180° C., (b) a non-crystalline resin having a glass transition temperature of −50 to 150° C., and (c) a mixture thereof, and contained at 1 to 30% by mass in the thermoadhesive layer.

The method of the present invention for producing IC cards or IC tags comprises using, as a constituent thereof, a core sheet prepared by arranging the aforementioned thermoadhesive film on one face or both faces of an inlet having an antenna circuit and an IC chip provided on a plastic film and pasting the inlet by hot pressing via the thermoadhesive layer of the thermoadhesive film.

The IC card or IC tag of the present invention comprises, as a constituent thereof, a core sheet prepared by laminating the aforementioned thermoadhesive film on one face or both faces of an inlet having an antenna circuit and an IC chip provided on a plastic film, and pasting the inlet via the thermoadhesive layer of the thermoadhesive film. Another preferred embodiment is an IC card or an IC tag wherein a polyester sheet or a biaxially stretched polyester film is laminated on both faces of the core sheet.

Embodiments of the present invention are hereinafter described in detail.

### [Configuration of Film]

The thermoadhesive polyester film of the present invention consists of a configuration wherein a thermoadhesive layer is laminated on one face or both faces of a substrate. Using a biaxially stretched polyester film as the substrate is important in terms of environmental suitability (not containing a halogen compound), as well as heat resistance, chemical resistance, strength, rigidity and the like. Thereby, these characteristics are dramatically improved, compared to conventionally used non-oriented PVC sheets, PETG sheets and the like.

For the thermoadhesive polyester film of the present invention, it is important that a thermoadhesive layer be present on one face or both faces thereof. As mentioned herein, a thermoadhesive layer is a layer that can be thermally pasted under heating conditions to the plastic film or sheet, a metal membrane, or various coating layers formed thereon that constitutes the IC card or IC tag. By laminating this thermoadhesive layer on the substrate, thermal adhesiveness equivalent to that of PVC, PETG and the like, which are materials for conventional IC cards or IC tags, can be conferred. It is important that the thickness of this thermoadhesive layer be not less than 5 μm and not more than 30 μm per layer. If the thickness of the thermoadhesive layer is less than 5 μm, the thermal adhesiveness and ruggedness absorbability are insufficient. If the thickness of the thermoadhesive layer exceeds 30 μm, the heat resistance and chemical resistance decrease as with conventional cards using a PETG sheet as the material. The lower limit of the thickness of the thermoadhesive layer is preferably 8 μm, more preferably 10 μm. The upper limit of the thickness of the thermoadhesive layer is preferably 25 μm, more preferably 20 μm.

Although the means for furnishing a thermoadhesive layer on the surface of the substrate is not subject to limitation, to achieve stable lamination in the above-described range of thickness, it is preferable to produce a non-stretched sheet using a method comprising co-extruding and laminating two kinds of resin, i.e., what is called the co-extrusion method, in the raw material molten extrusion step in the manufacturing process for biaxially stretched polyester film. From the viewpoint of conferring adequate heat resistance to the thermoadhesive layer, it is preferable that lamination be performed before the stretching step, and both the thermoadhesive layer and the substrate (biaxially stretched polyester film) layer be subjected to stretching processing.

In the thermoadhesive polyester film of the present invention, it is a preferred mode of embodiment to furnish a thermoadhesive layer on both faces of the substrate because of suppression of curls of the film. In the present invention, the thermoadhesive layer is configured mainly with a non-crystalline resin, having a coefficient of thermal expansion widely different from that of the substrate, which is based on a crystalline polyester resin. For this reason, if the thermoadhesive layer is provided on only one face of the substrate, the film sometimes curls like a bimetal, depending on processing conditions and use conditions; failures in flatness and handlability are of concern. If the thermoadhesive layer is provided on both faces of the substrate, the ratio of the thicknesses of the thermoadhesive layers on the top and back faces is preferably not less than 0.5 and not more than 2.0. If the ratio deviates from this range, curls sometimes occur for the above-described reason. Even if a curl has occurred, there is no substantial disturbance on the handlability, provided that the curl value after heat treatment without a load at 110° C. for 30 minutes is not more than 5 mm. More preferably, the curl value is not more than 3 mm, particularly preferably not more than 1 mm.

Another method of suppressing curls is available wherein the temperature or calorific value exerted is passively differentiated between the top face and the back face of the film so as to make the curl value approach zero. Specifically, by having different values of temperature or calorific value between the top and back faces of the film in steps for stretching such as longitudinal stretching and lateral stretching and in the thermal fixation step, the degrees of orientation of the top face and the back face of the film are independently controlled to achieve a good balance of structure and physical properties between the top face and the back face of the film. As a result, curls can be reduced. When this method is used, in the heating/cooling step of the process for longitudinally stretching the film, it is easy to adjust the temperatures of the rolls and infrared heaters for heating the top face and the back face of the film; this is a preferable method.

For the thermoadhesive polyester film of the present invention, it is preferable that the thickness of the entire film be not less than 50 μm and not more than 350 μm. The lower limit of the thickness of the entire film is more preferably 70 μm, still more preferably 90 μm. The upper limit of the thickness of the entire film is more preferably 280 μm, still more preferably 200 μm. If the thickness of the entire film is less than 50 μm, the thickness is no longer sufficient for the substrate of an IC card or IC tag, and does not contribute to the improvement of the heat resistance of the entire card and the like. If the thickness of the entire film exceeds 350 μm, combinations with other sheets or films or electrical circuits are limited under the requirement for the standard thickness of cards (0.76 mm for cards in the JIS standards).

In the thermoadhesive polyester film of the present invention, for further improving the thermal adhesiveness and sliding quality, or for conferring others function such as antistatic quality, it is also possible to furnish a coating layer on the surface of the film. As resins and additives that constitute the coating layer, resins used to improve the adhesive quality of ordinary polyester films, such as polyester resin, polyurethane resin, polyester urethane resin, and acrylic resin, or antistatic agents that improve antistatic quality and the like can be mentioned. As a criterion for choosing a preferable one from among these resins and additives, it is preferable that the resin or additive chosen have high affinity for the thermoadhesive polyester film of the present invention and the material laminated thereon. Specifically, it is preferable that a resin or additive having similar values of surface tension and solubility parameter be chosen. However, if a setting resin is thickly applied, ruggedness absorbability, which is an important effect of the present invention, is possibly affected, and cautions are needed.

As the method for furnishing the coating layer, methods in common use, such as the gravure coating method, kiss coating method, dip method, spray coating method, curtain coating method, air knife coating method, blade coating method, and reverse roll coating method, can be applied. Regarding the timing of coating, any of a method comprising coating before film stretching, a method comprising coating after longitudinal stretching, a method comprising coating to the film surface after completion of orientation treatment and the like can be used.

### [Thermoadhesive Layer]

In the thermoadhesive polyester film of the present invention, it is important that the thermoadhesive layer have a non-crystalline polyester resin A as the major constituent thereof.

As mentioned herein, a non-crystalline polyester resin A refers to a polyester resin having an amount of heat of fusion of not more than 20 mJ/mg. An amount of heat of fusion is measured in a nitrogen atmosphere with heating at a speed of 10° C./min using a DSC apparatus according to the “Testing Methods for Heat of Transitions of Plastics” specified in JIS-K7122. In the present invention, the aforementioned amount of heat of fusion is preferably not more than 10 mJ/mg; more preferably, substantially no fusion peak is observed. If the amount of heat of fusion exceeds 20 mJ/mg, the thermoadhesive layer becomes unlikely to deform, and no sufficient ruggedness absorbability is obtained.

It is important that the non-crystalline polyester resin A have a glass transition temperature of not less than 50° C. and not more than 95° C. The aforementioned glass transition temperature means the midpoint glass transition temperature (Tmg) as determined on the basis of the DSC curve obtained in a nitrogen atmosphere with heating at a speed of 10° C./min using a DSC apparatus according to the “Testing Methods for Transition Temperatures of Plastics” specified in JIS-K7121. The lower limit of the glass transition temperature of the non-crystalline polyester resin A is preferably 60° C., more preferably 70° C. The upper limit of the glass transition temperature is preferably 90° C., more preferably 85° C. If the glass transition temperature is less than 50° C., the IC card or IC tag prepared deforms due to a lack of heat resistance, or the thermoadhesive layer peels again with slight heating, when the non-crystalline polyester resin A is used in IC cards or IC tags. If the glass transition temperature exceeds 95° C., it becomes necessary to heat the resin at higher temperatures in producing IC cards or IC tags, so that the burden on electrical circuits and the like increases.

Although the choice of the non-crystalline polyester resin A is not subject to limitation, from the viewpoint of versatility, costs, durability or thermal adhesiveness for PETG sheets and the like, an aromatic polyester resin, represented by polyethylene terephthalate, having various copolymer ingredients introduced to the molecular skeleton thereof, is preferably used. As glycol ingredients out of the copolymer ingredients introduced, ethylene glycol, diethylene glycol, neopentyl glycol (NPG), cyclohexane dimethanol (CHDM), propanediol, butanediol and the like can be mentioned. As acid ingredients, terephthalic acid, isophthalic acid, naphthalene dicarboxylic acid and the like can be mentioned. As copolymer ingredients, monomers capable of lowering the glass transition temperature to improve the thermal adhesiveness at low temperatures is chosen. As such polymer ingredients, glycols having long linear chain ingredients, or ingredients of nonlinear structure showing great steric hindrance can be mentioned. The latter ingredients are used when it is intended to effectively reduce the crystallinity of the thermoadhesive layer to improve the ruggedness absorbability. In the present invention, from the viewpoint of thermal adhesiveness for PETG sheets, CHDM and NPG are preferable, and NPG is more preferable.

As the non-crystalline polyester resin A, there are some resins generally developed for use in adhesives, and commercially available. When such a resin for adhesives is used, it is possibly adherable to a broad range of materials because it has been developed essentially as an adhesive. However, such resins for adhesives are sometimes difficult to co-extrude stably in the manufacturing step for biaxially stretched films. In this case, it is necessary to control the temperature of the extruder, and to well adjust the thickness of the thermoadhesive layer and the like.

In the present invention, the thermoadhesive layer comprises a non-crystalline polyester resin A and a non-crystalline or crystalline thermoplastic resin B incompatible therewith, forming a sea-island structure. The thermoplastic resin B occurs as a dispersion (island structure) in the thermoadhesive layer. Projections resulting from the island structure of this sea-island structure are effective in that they confer sliding quality to thermoadhesive polyester films, and that they do not interfere with the thermal adhesiveness and transparency because they crash and flatten in the thermal adhesion step.

Described below are non-crystalline thermoplastic resins and crystalline thermoplastic resins that can be used as the thermoplastic resin B.

The above-described non-crystalline thermoplastic resins refer to thermoplastic resins having an amount of heat of fusion of not more than 20 mJ/mg. An amount of heat of fusion is measured in a nitrogen atmosphere with heating at a speed of 10° C./min using a DSC apparatus according to the “Testing Methods for Heat of Transitions of Plastics” specified in JIS K 7122.

A non-crystalline thermoplastic resin forms an island structure in the non-crystalline polyester resin in the thermoadhesive layer, and projections resulting therefrom are formed on the surface of the thermoadhesive layer. These projections must maintain sufficient hardness at room temperature to improve the sliding quality of the film. Hence, in the present invention, when a non-crystalline thermoplastic resin is used as the thermoplastic resin B serving as the island ingredient, it is important that the glass transition temperature of the resin be not less than −50° C. and not more than 150° C. The above-described glass transition temperature means a midpoint glass transition temperature as determined in a nitrogen atmosphere under heating at 10° C./min using a DSC apparatus by the “Testing Methods for Transition Temperatures of Plastics” specified in JIS K 7121.

The lower limit of the glass transition temperature of the non-crystalline thermoplastic resin is preferably −20° C., more preferably 0° C. If the glass transition temperature of the non-crystalline thermoplastic resin is less than −50° C., the sliding quality needed in handling the film is sometimes not obtained, or the thermoplastic resin ingredient sometimes oozes out on the surface after an IC card or an IC tag is produced.

These projections resulting from the sea-island structure crash and flatten in the thermal adhesion step, thus working in a way that does not to interfere with the thermal adhesiveness and transparency. Usually, the hot pressing performed in producing an IC card or an IC tag is performed at 80 to 150° C. Hence, the upper limit of the glass transition temperature of the above-described non-crystalline thermoplastic resin is more preferably 130° C., still more preferably not more than 100° C. If the glass transition temperature of the non-crystalline thermoplastic resin exceeds 150° C., problems arise: (a) no sufficient thermal adhesiveness is obtained, (b) thermal adhesion at higher temperatures becomes necessary, so that the burden on electrical circuits and the like increases, or (c) the flatness of the adhesion interface is insufficient and the transparency after adhesion worsens.

On the other hand, in the present invention, as the thermoplastic resin B used in the thermoadhesive layer, a crystalline thermoplastic resin can be used. The crystalline thermoplastic resin refers to a thermoplastic resin having a heat of fusion exceeding 20 mJ/mg. An amount of heat of fusion is measured in a nitrogen atmosphere with heating at a speed of 10° C./min using a DSC apparatus according to the “Testing Methods for Heat of Transitions of Plastics” specified in JIS K 7122.

Because this crystalline thermoplastic resin is incompatible with the non-crystalline polyester resin A, it forms an island structure as a dispersion in the non-crystalline polyester resin, resulting in the formation of projections on the thermoadhesive layer surface. These projections must maintain hardness at room temperature to improve the sliding quality of the film. Hence, it is important that the crystalline thermoplastic resin be a resin having a melting point of not less than 50° C. and not more than 200° C. The melting point of the crystalline thermoplastic resin is measured in a nitrogen atmosphere with heating at a speed of 10° C./min using a DSC apparatus according to the “Testing Methods for Transition Temperatures of Plastics” specified in JIS K 7121.

The lower limit of the melting point of the crystalline thermoplastic resin is more preferably 70° C., still more preferably 90° C. To allow the resin to work in a way that does not interfere with adhesion by crashing and flattens in the thermal adhesion step, it is undesirable that the melting point of the resin exceeds the maximum temperature in the thermal adhesion step by more than 30° C. More specifically, the upper limit of the melting point of the resin is more preferably 180° C., still more preferably 160° C.

In the present invention, the thermoplastic resin used in the thermoadhesive layer is not subject to limitation; because the thermoplastic resin is used in a blend with a non-crystalline polyester resin, a resin having a solubility parameter higher or lower by not less than 2.0 (J/cm³)^{1/2} than that of polyethylene terephthalate is suitable.

As non-crystalline highly versatile resins, polystyrene, polycarbonate, acrylics, cyclic olefins or copolymers thereof, low-density olefins of low stereoregularity such as polypropylene and polyethylene or copolymers thereof, and the like can be mentioned; because of high stability to heat, ultraviolet rays, and oxygen, and higher versatility, polystyrene and polyolefins are preferable; because of high heat resistance, polystyrene or cyclic olefin copolymers are more preferable.

As crystalline highly versatile resins, polyethylene, polypropylene, polybutadiene, polyethylene propylene rubber, polylactic acid, polyoxymethylene and the like can be mentioned. Of these resins, polyethylene or polypropylene is preferable because of the high stability to heat, ultraviolet rays, and oxygen, and higher versatility; because of the appropriate melting point, polyethylene or polypropylene is more preferable. Because of the crystallinity, the polyethylene is preferably a high-density polyethylene having a density exceeding 0.90 g/cm³ or a linear low-density polyethylene.

In the present invention, the amount of the thermoplastic resin B contained in the thermoadhesive layer is not less than 1% by mass and not more than 30% by mass, relative to the materials that constitute the thermoadhesive layer. The lower limit of the content of the thermoplastic resin B is preferably 3% by mass, more preferably 5% by mass. The upper limit of the content of the thermoplastic resin B is preferably 25% by mass, more preferably 20% by mass. If the content of the thermoplastic resin B is less than 1% by mass, the necessary sliding quality cannot be obtained. If the content of the thermoplastic resin B exceeds 30% by mass, rough projections are formed, which sometimes drop off from the surface of the film, or conversely worsen the sliding quality, or do not flatten sufficiently by hot pressing to worsen the thermal adhesiveness and reduce the transparency.

In the present invention, it is preferable that the maximum height of the surface of the thermoadhesive layer be not less than 1.0 μm and not more than 10 μm. The lower limit of the maximum height of the surface of the thermoadhesive layer is more preferably 1.2 μm, particularly preferably 1.5 μm. The upper limit of the maximum height of the surface of the thermoadhesive layer is more preferably 8.0 μm, particularly preferably 5.0 μm. If the maximum height of the surface of the thermoadhesive layer is less than 1.0 μm, no sufficient sliding quality is obtained, and the film becomes difficult to handle. If the maximum height of the surface of the thermoadhesive layer exceeds 10 μm, the projections on the surface of the film drop off due to rubbing and contaminate the process, or conversely worsen the sliding quality.

In the present invention, it is preferable that the ratio (St1/Sa1) of the maximum height of the surface of the thermoadhesive layer (St1) and the arithmetic mean surface roughness (Sa1) be not less than 3.0 and not more than 20. The lower limit of St1/Sa1 is more preferably 5.0, particularly preferably 7.0. The upper limit of St1/Sa1 is more preferably 16, particularly preferably 12. If St1/Sa1 is less than 3.0, it is difficult to improve the sliding quality. If St1/Sa1 exceeds 20, it is difficult to obtain thermal adhesiveness.

As methods of regulating the maximum height of projections on the surface of the thermoadhesive layer in an appropriate range, (1) a method comprising choosing a melt viscosity and glass transition temperature of the non-crystalline polyester resin A, (2) a method comprising choosing a melt viscosity, glass transition temperature, melting point, surface tension, solubility parameter, and amount added of the thermoplastic resin B, (3) a method comprising choosing a temperature for extruding the resin of the thermoadhesive layer to the film surface and the like can be mentioned. Of these methods, a method comprising regulating the glass transition temperature of the non-crystalline polyester resin, and the choice, amount added, and extrusion temperature of the thermoplastic resin is easy and reliable.

In the present invention, the maximum height of projections (St2) on the surface of the thermoadhesive layer after the thermoadhesive layer is sandwiched between a pair of smooth and clean glass plates with both surfaces facing the glass plates, and subjected to hot press treatment (100° C., 1 MPa, 1 minute) is preferably not less than 0.001 μm and not more than 3.000 μm.

The lower limit of St2 is more preferably 0.005 μm, most preferably 0.01 μm. The upper limit of St2 is more preferably 2.500 μm, most preferably not more than 2.000 μm. If St2 is less than 0.005 μm, the resin that constitutes the thermoadhesive layer can fluidize to make the processing stability insufficient during hot pressing. If St2 exceeds 0.01 μm, a large number of projections remain even after hot pressing, so that no sufficient adhesion interface to assure a stable adhesive force is obtained; therefore, this is undesirable. To regulate St2 in the range from 0.001 to 3.00 μm, it is effective to adjust the melting point of the crystalline thermoplastic resin in the range from 50 to 200° C., or to regulate the content of the crystalline thermoplastic resin in the range from 1 to 30% by mass.

In the thermoadhesive polyester film of the present invention, it is preferable that the top surface and the back face of the film be faced with each other, and that the coefficient of static friction in the interface thereof be not less than 0.1 and not more than 0.8. The lower limit of the coefficient of friction is more preferably 0.2. The upper limit of the coefficient of friction is more preferably 0.7, still more preferably 0.6, particularly preferably 0.5. It is difficult within the technical scope of the present invention to make the coefficient of static friction between the top surface and the back face of the film to be less than 0.1. If the above-described coefficient of static friction exceeds 0.8, the handlability of the film worsens remarkably. To regulate the coefficient of static friction in the range from 0.1 to 0.8, it is preferable to regulate the maximum height of the surface of the thermoadhesive layer as described above, or to regulate the elastic modulus or surface tension of the thermoadhesive layer.

The ruggedness absorbability of IC chips and electrical circuits arranged in the core sheet of an IC card or an IC tag can be expressed as parameters called shaping rate and the gradient of the outer margin of the shaping portion as indexes of shapability by hot pressing. Here, the shaping rate means the depth of the depression of the thermoadhesive layer produced by an antenna circuit or a copper foil piece when the antenna circuit or the copper foil piece is placed on the surface of the thermoadhesive layer and hot-pressed, and then removed at normal temperature and normal pressure; the gradient of the outer margin of the shaping portion means the gradient of the wall face in the outer margin of this depression.

In the thermoadhesive polyester film of the present invention, it is preferable that the shaping rate by hot pressing be not less than 40% and not more than 105%. From the viewpoint of the absorption of ruggedness in an IC chip or electrical circuit by the present invention, the lower limit of the shaping rate is more preferably 50%, still more preferably 60%.

From this viewpoint, of course, it is ideal that the upper limit of the shaping rate is as high as possible. However, because it is feared that the processing stability decreases if the thermoadhesive layer softens and fluidizes in the hot press step, realistically it is more preferable that the shaping rate be not more than 102%, more realistically not more than 98%. As a method for adjusting the shaping rate to from 40% to not more than 105%, it is important that in addition to adjusting the thickness of the thermoadhesive layer to not less than 5 μm, the glass transition temperatures, melting points, blending ratios, viscosities, elastic moduli and the like of the non-crystalline polyester resin A and thermoplastic resin B that constitute the thermoadhesive layer be adjusted as appropriate.

In the present invention, it is preferable that the gradient of the outer margin of the shaping portion due to hot pressing be not less than 20% and not more than 1000%. From the viewpoint of the absorption of ruggedness in an IC chip or electrical circuit by the thermoadhesive layer in the present invention, it is preferable that the shape of the depression undergoing shaping fit the external shape of the electrical circuit and the like. The fact that the gradient of the outer margin of the shaping portion is less than 20% means a state wherein a portion around the convex in the electrical circuit and the like has also deformed, or the shape of the convex is not sufficiently absorbed. This gradient is more preferably not less than 50%, still more preferably not less than 100%.

From the viewpoint of ruggedness absorbability, of course, the deformation approaches the ideal level as the gradient of the outer margin of the shaping portion due to hot pressing increases; geometrically, it is most preferable that the gradient be infinite. However, the highest really achievable level within the technical scope disclosed in the present invention is up to 1000% of the upper limit, and the highest really achievable level with a more common processing step is not more than 500%. As a method for adjusting the gradient of the outer margin of the shaping portion due to hot pressing in the range from 20 to 1000%, it is important that in addition to adjusting the thickness of the thermoadhesive layer to not less than 5 μm, the glass transition temperatures, blending ratios, viscosities, elastic moduli and the like of the non-crystalline polyester resin A or non-crystalline thermoplastic resin B that constitute the thermoadhesive layer be adjusted as appropriate.

In the thermoadhesive polyester film of the present invention, if the film does not need special transparency, or particularly the film is used as a raw material for cards or tags that are white and require hiding quality, it is a preferred embodiment that a white pigment is contained in the thermoadhesive layer, as far as the thermal adhesiveness, sliding quality, and ruggedness absorbability are not interfered with. As the white pigment contained in the thermoadhesive layer, titanium oxide, calcium carbonate, barium sulfate and complexes thereof are preferable; from the viewpoint of hiding effect, it is more preferable to use titanium oxide. These inorganic particles are preferably contained in the range of not more than 30% by mass, relative to the constituent materials of the biaxially stretched polyester film which is the substrate, and more preferably not more than 20% by mass. If the inorganic particles are added at levels exceeding the range, the above-described characteristics are sometimes interfered with.

In the thermoadhesive polyester film of the present invention, organic particles may be contained in the thermoadhesive layer, as far as the thermal adhesiveness, sliding quality, and ruggedness absorbability are not interfered with. By containing organic particles in the thermoadhesive layer, projections can be formed on the surface of the thermoadhesive layer; in producing a card by thermal adhesion using a hot press, it is possible to effectively eliminate the bubbles between films. As the organic particles, melamine resin, crosslinked polystyrene resin, crosslinked acrylic resin and complex particles based thereon are preferable. These inorganic particles are preferably contained in the range of not more than 30% by mass, relative to the constituent materials of the thermoadhesive layer, and more preferably not more than 20% by mass. If the particles are added at levels exceeding the above-described range, the above-described characteristics are sometimes interfered with.

### [Biaxially Stretched Polyester Film Layer (Substrate Film)]

The thermoadhesive polyester film of the present invention has at least one biaxially stretched polyester film layer as the substrate. This layer can have the optical characteristics and mechanical characteristics thereof regulated easily by commonly known conventional methods. That is, if the thermoadhesive polyester film of the present invention is used as a white or highly hiding IC card or IC tag, it is a preferred embodiment to contain a large number of fine hollows or a white pigment in the substrate film. If no hiding quality is needed, and also if transparency or strength is preferentially desired, it is a preferred embodiment to use a biaxially stretched polyester film containing minimum possible levels of inorganic particles, foreign matter and the like.

If the thermoadhesive polyester film of the present invention is used as a raw material for a white or highly hiding IC card or IC tag, a hollow-containing polyester film containing a large number of fine hollows therein is preferable as the substrate film. It is preferable that by a large number of fine hollows in the film, the apparent density of the film be controlled at not less than 0.7 g/cm³ and not more than 1.2 g/cm³. The lower limit of the apparent density of the film is more preferably 0.8 g/cm³, still more preferably 0.9 g/cm³. The upper limit of the apparent density of the film is more preferably 1.2 g/cm³, still more preferably 1.1 g/cm³. If the apparent density of the film is less than 0.7 g/cm³, the strength, buckling resistance, and compression recovery rate of the film decrease, and the appropriate performance for the processing or use of the IC card or IC tag is no longer obtained. If the apparent density of the film exceeds 1.2 g/cm³, lightness and flexibility for an IC card or IC tag are no longer obtained.

As methods of containing hollows in the film, (1) a method comprising containing a foaming agent, and causing foaming by the heat produced during extrusion or film making, or causing foaming by chemical decomposition, (2) a method comprising adding a gas such as gaseous carbon dioxide or a gassifiable substance during extrusion or after extrusion, and causing foaming, (3) a method comprising adding a polyester and a thermoplastic resin incompatible with the polyester, extruding them in a molten state, and then monoaxially or biaxially stretching them, (4) a method comprising adding organic or inorganic fine particles, extruding them in a molten state, and then monoaxially or biaxially stretching them, and the like can be mentioned.

Of the above-described methods of containing hollows in the film, the method (3) above, that is, a method comprising adding a thermoplastic resin incompatible with polyester, extruding them in a molten state, and then monoaxially or biaxially stretching them, is preferable. The thermoplastic resin incompatible with polyester resin is not limited by any means; for example, polyolefin-series resins represented by polypropylene and polymethylpentene, polystyrene-series resins, polyacrylic resin, polycarbonate resin, polysulfone-series resins, cellulose-series resins, polyphenylene ether-series resins and the like can be mentioned.

These thermoplastic resins may be used singly or in combination of a plurality of thermoplastic resins. The content of the thermoplastic resin incompatible with polyester resin is preferably 3 to 20% by mass, more preferably 5 to 15% by mass, relative to the resin that forms the hollow-containing polyester layer. If the content of the thermoplastic resin incompatible with polyester resin is less than 3% by mass, relative to the resin that forms the hollow-containing polyester layer, the amount of hollows formed in the film decreases so that the hiding quality decreases. If the content of the incompatible thermoplastic resin exceeds 20% by mass, relative to the resin that constitutes the white polyester layer, breakage in the film manufacturing step occurs frequently. The hollow content ratio in the hollow-containing polyester film is preferably 10 to 50% by volume, more preferably 20 to 40% by volume.

When the thermoadhesive polyester film of the present invention is used as a raw material for white or highly hiding IC cards or IC tags, a white polyester film comprising a biaxially stretched polyester layer containing a white pigment is also a preferred embodiment of the substrate film. The white pigment used here is not subject to limitation; from the viewpoint of versatility, one comprising titanium oxide, calcium carbonate, barium sulfate or a complex thereof is preferable; from the viewpoint of hiding effect, it is more preferable to use titanium oxide. These inorganic particles are preferably contained in the range of not more than 25% by mass, relative to the constituent material of the white polyester layer, more preferably not more than 20% by mass. If the inorganic particles are added at levels exceeding the above-described range, breakage in the film manufacturing step can occur frequently to make stable production at industrial levels difficult.

When the thermoadhesive polyester film of the present invention is used as a raw material for white or highly hiding IC cards or IC tags, it is preferable that the content of fine hollows or white pigment be adjusted as appropriate to obtain an optical density of not less than 0.5 and not more than 3.0. The lower limit of the optical density is more preferably 0.7, still more preferably 0.9. The upper limit of the optical density is more preferably 2.5, still more preferably 2.0. If the optical density is under the above-described range, inside structures such as IC chips and electrical circuits are sometimes seen through the surface due to a lack of hiding quality when the film is prepared as an IC card or IC tag, and this is undesirable for design and security. To produce a film wherein the optical density exceeds the above-described range, it is unavoidable to increase the content of fine hollows and white pigment in the film very much, and the film strength and the like decrease.

When the thermoadhesive polyester film of the present invention is used as a raw material for white or highly hiding IC cards or IC tags, it is most preferable that a method comprising blending a thermoplastic resin incompatible with the polyester resin to form hollows and a method comprising blending a white pigment be used in combination.

When the thermoadhesive polyester film of the present invention is used as a raw material for transparent IC cards or IC tags, the light transmittance of the film is preferably not less than 25% and not more than 98%. By adjusting the light transmittance of the film in the aforementioned range, clear and beautiful cards of excellent design quality can be obtained. The lower limit of the light transmittance of the film is more preferably 30%, still more preferably 40%. If the lower limit of the light transmittance of the film is less than 25%, the transparency is insufficient and no design quality is obtained. The upper limit of the light transmittance of the film is more preferably 90%, still more preferably 80%. From the viewpoint of design quality, of course, the light transmittance is preferably as high as possible. However, if an IC card or IC tag having a light transmittance of the film exceeding 98% is produced, it is difficult to obtain sliding quality enduring practical use.

In the thermoadhesive polyester film of the present invention, each layer, excluding the thermoadhesive layer, is preferably configured mainly with a crystalline polyester. As mentioned here, a crystalline polyester resin refers to a polyester resin having an amount of heat of fusion exceeding 20 mJ/mg. The method for determination of an amount of heat of fusion is the same as the aforementioned one.

Such a crystalline polyester is a polyester produced by polymerization-condensation of an aromatic dicarboxylic acid such as terephthalic acid, isophthalic acid, or naphthalene dicarboxylic acid or an ester thereof and a glycol such as ethylene glycol, diethylene glycol, 1,3-propanediol, 1,4-butanediol, or neopentyl glycol in an appropriate ratio. These polyesters can be produced by the direct polymerization method, wherein an aromatic dicarboxylic acid and a glycol are directly reacted, as well as the ester exchange method, wherein an alkyl ester of aromatic dicarboxylic acid and a glycol are subjected to an ester exchange reaction and then to polymerization-condensation, or a method wherein an aromatic dicarboxylic acid diglycol ester is subjected to polymerization-condensation and the like.

As representative examples of the aforementioned crystalline polyester, polyethylene terephthalate, polytrimethylene terephthalate, polybutylene terephthalate and polyethylene-2,6-naphthalate can be mentioned. The aforementioned polyester may be a homopolymer, or a copolymer of a third ingredient. Of these polyesters, polyesters wherein the ethylene terephthalate unit, trimethylene terephthalate unit, or ethylene-2,6-naphthalate unit accounts for nor less than 70 molar %, preferably not less than 80 molar %, more preferably not less than 90 molar %, are preferable.

### [IC Card or IC Tag, and Method of Production Thereof]

The IC card or IC tag of the present invention can be produced by using a core sheet prepared by arranging the aforementioned thermoadhesive film on one face or both faces of an inlet provided with an antenna circuit and an IC chip on a plastic film, and pasting the inlet by hot pressing via the thermoadhesive layer of the thermoadhesive film, as a constituent thereof. A more preferable method of producing an IC card or IC tag is a method comprising further laminating a polyester sheet (for example, non-oriented PETG sheet) or a biaxially stretched polyester film on both faces of the aforementioned core sheet, and then hot pressing them to bond the members together to obtain a unified structure.

An inlet refers to a product form wherein an IC chip is mounted on an antenna circuit or a metal coil, comprising a configuration wherein an antenna circuit and an IC chip are provided on one face of a plastic film. This is the most basic product form, and the antenna circuit or metal coil and the IC chip are in an exposed state.

Usually, when a card is configured using a biaxially stretched polyester film as the core material, the use of an adhesive such as a hot melt sheet is essential; however, the thermoadhesive polyester film of the present invention does not require this, and allows an improvement of the production efficiency for cards and tags and a reduction of manufacturing costs.

The IC card or IC tag of the present invention comprises a core sheet prepared by laminating the aforementioned thermoadhesive film on one face or both faces of an inlet provided with an antenna circuit and an IC chip on a plastic film, and pasting the inlet via the thermoadhesive layer of the thermoadhesive film, as a constituent thereof. Another preferred embodiment is an IC card or IC tag wherein a polyester sheet or a biaxially stretched polyester film is laminated on both faces of the core sheet.

Cards and tags refer to shapes and intended uses of articles; as far as they comprise an inlet provided with an antenna circuit or a metal coil and an IC chip on a plastic film, cards and tags having shapes or intended uses different from those of IC cards, IC tags and the like are also encompassed in the present invention.

Because the thermoadhesive polyester film of the present invention has a thermoadhesive layer comprising a non-crystalline polyester on one face or both faces thereof, the film can be plastered to a known polyester sheet or polyester film without using an adhesive. Although the polyester sheet is not subject to limitation, it is preferable to use a polyester sheet of low crystallinity or no crystallinity wherein an ingredient such as isophthalic acid, cyclohexane dimethanol or neopentyl glycol is copolymerized to polyethylene terephthalate. If a biaxially stretched polyester film is used, the choice thereof is not subject to limitation, but it is preferable to use a white polyester film or hollow-containing polyester film suitable for cards or tags. Furthermore, it is a more preferred embodiment to use a biaxially stretched polyester film wherein a surface-treated layer with improved printability or adhesiveness is formed.

In producing IC cards or IC tags by the present invention, it is preferable that the inlet having an antenna circuit and an IC chip be arranged in a state adjoining to at least one face of the thermoadhesive polyester film of the present invention. The thermoadhesive layer of the present invention can easily be deformed in the hot press step, and the ruggedness resulting from the circuit or chip can be efficiently modified, whereby cards and tags of beautiful appearance can be produced.

In the present invention, if cards or tags are produced by the hot press adhesion method, the temperature at the time of hot pressing is preferably 90 to 160° C., more preferably 110 to 150° C. If the temperature at the time of hot pressing is less than 90° C., no sufficient adhesive force can be obtained. If the temperature at the time of hot pressing exceeds 160° C., the film undergoes considerable thermal shrinkage, resulting in an unbeautiful card shape, and this is undesirable in terms of design.

The pressure at the time of hot pressing is preferably 0.1 to 20 MPa, more preferably 0.3 to 10 MPa. If the pressure at the time of hot pressing is less than 0.1 MPa, the card flatness is insufficient, and no beautiful appearance is obtained. If the pressure at the time of hot pressing exceeds 20 MPa, and even if a thermoadhesive polyester film with a hollow-containing polyester film as the substrate is used, the effects of the excellent cushion quality and ruggedness absorbability thereof are reduced by the high pressure. As a result, the burden on circuits such as IC chips becomes so large that electrical failures are likely to occur.

A preferred embodiment of the IC card or IC tag of the present invention is an IC card or IC tag using a thermoadhesive polyester film with a hollow-containing film containing a large number of fine hollows therein as the substrate (the apparent density is 0.7 to 1.3 g/cm³), and having an apparent density of not less than 0.7 g/cm³ and less than 1.3 g/cm³. The lower limit of the apparent density of the card or tag is more preferably 0.8 g/cm³, still more preferably 0.9 g/cm³. The upper limit of the apparent density of the card or tag is more preferably 1.2 g/cm³, still more preferably 1.1 g/cm³. If the apparent density of the card or tag is less than 0.7 g/cm³, the strength, buckling resistance, or compression recovery rate of the card or tag decrease, and the appropriate mechanical performance for the processing or use of the IC card or IC tag is no longer obtained. If the apparent density of the card or tag is not less than 1.3 g/cm³, the lightness and flexibility for an IC card or IC tag are no longer obtained. If having an apparent density of not less than 0.7 g/cm³ and less than 1.3 g/cm³, the IC card or IC tag rises to the water surface, or sufficient time to recover the IC card or IC tag before sinking can be obtained, in the event of accidental submergence. Hence, the card in this embodiment is suitable as, for example, a personal information recording card to be routinely carried by a person with the information recorded therein.

Another preferred embodiment of the IC card of the present invention is an IC card prepared using the thermoadhesive polyester film of the present invention having a light transmittance of not less than 25% and not more than 98%, wherein the light transmittance of the card (excluding the electronic circuit portion) is not less than 10% and not more than 98%. By controlling the light transmittance of the card in the range from 25 to 98%, an IC card of excellent fashionability and event quality can be provided. The lower limit of the light transmittance of the card is more preferably 20%, still more preferably 30%. If the lower limit of the light transmittance is less than 25%, the transparency is insufficient and no preferable design quality is obtained. The upper limit of the light transmittance is more preferably 90%, still more preferably 80%. From the viewpoint of design quality, of course, the light transmittance is preferably as high as possible. However, if a card having a light transmittance exceeding 98% is produced, it is difficult to obtain a sliding quality enduring practical use, and this is unrealistic.

A preferred embodiment of the IC tag of the present invention is an IC tag prepared using the thermoadhesive polyester film of the present invention having a light transmittance of not less than 25% and not more than 98%, wherein the light transmittance of the tag (excluding the electronic circuit portion) is not less than 10% and not more than 98%. By controlling the light transmittance of the tag in the range from 25 to 98%, management information, cargo destination address, personal names and the like written in the back face portion of the tag and the like can be efficiently visualized. For this reason, the lower limit of the light transmittance is more preferably 20%, still more preferably 30%. The upper limit of the light transmittance is preferably 90%, more preferably 80%. From the viewpoint of visibility, of course, the light transmittance is preferably as high as possible. However, if an IC tag having a light transmittance exceeding 98% is produced, it is difficult to obtain a sliding quality enduring practical use, and this is unrealistic.

### EXAMPLES

Next, the connection between the technical requirements and effect of the present invention are described in more detail by means of the following Examples and Comparative Examples. The characteristic values used in the present invention were evaluated using the methods described below.

### [Methods of Evaluation]

### (1) Melting Point and Glass Transition Temperature of Resin

DSC measurements were performed by the “Testing Methods for Transition Temperatures of Plastics” specified in JIS K 7121. The sample used was an about 10 mg small piece obtained by cutting the thermoadhesive layer from the film using a microtome equipped with a magnifier, sealed in an aluminum pan and molten at 300° C. for 3 minutes, and quenched with liquid nitrogen. The measurements were performed using a differential scanning calorimeter (manufactured by Seiko Instruments Inc., EXSTAR6200DSC) in a dry nitrogen atmosphere. After the midpoint glass transition temperature was determined with heating from room temperature at a speed of 10° C./minute, the fusion peak temperature (melting point) was determined.

### (2) Amount of Heat of Fusion of Resin

An amount of heat of fusion was determined by the “Testing Methods for Heat of Transitions of Plastics” specified in JIS K 7122. The details of DSC measurements were the same as those of the above-described determination of melting point.

### (3) Film Thickness

Determined by the “Cellular plastics—Film and sheeting—Determination of thickness” specified in JIS K 7130. The measuring instrument used was an electronic micrometer (manufactured by Mahr, Millitron 1240). Four 5 cm square samples were cut out from four optionally chosen sites of the subject film, measurements were taken at five points per sample (20 points in total), and mean thickness was obtained.

### (4) Film Lamination Thicknesses

Small chips were cut off from three optionally chosen sites of the subject film. Each small piece obtained was cut using a microtome to prepare a film cross-section perpendicular to the film surface. This section was sputtered with platinum-palladium alloy to obtain a sample, and the section was examined using a scanning electron microscope (manufactured by Hitachi, Ltd., S2500). The film was examined at an appropriate magnification rate to include the entire film thickness in one visual field, and the thickness of each layer was measured. Measurements were performed at three sites per visual field, and the mean value for a total of nine sites was used as the lamination thickness.

### (5) Film Surface Roughness

Small pieces were cut off from three optionally chosen sites of the subject film, and dust and others were carefully removed using an antistatic blower. The thermoadhesive layer surface of each piece was analyzed using a non-contact three-dimensional shape determination apparatus (manufactured by Micromap Company, Micromap 557). The optical system comprised a Mirau-type two-beam interference objective lens (×10) and a zoom lens (Body Tube, ×0.5), and the light was received with a ⅔-inch CCD camera using a 5600 Angstrom light source. Measurements were performed in the WAVE mode, and 1619 μm×1232 μm visual fields were processed as digital images of 640×480 pixels. The images were analyzed using analytical software (Micromap123, version 4.0) with detrending in the first-degree function mode. Thereby, the arithmetic mean surface roughness for five visual fields of each of the top and back faces of the above-described three samples (30 visual fields in total) were measured, and the mean value thereof was used as the surface roughness (Sa).

(6) Film Surface Roughness after Hot Press Treatment

A smooth clean glass plate (slide glass having an Sa of 0.0008 μm) was placed on each of both faces of the portion to be examined; both faces were covered with a cushion material (manufactured by Toyobo, hollow-containing polyester film K1212, 188 μm). After pre-heating at 100° C. for 5 minutes, this was hot-pressed (1 MPa, 1 minute). Except for these conditions, in the same manner as with the film surface roughness, the film surface roughness after the hot press treatment was measured.

### (7) Shaping Rate and Gradient of Outer Margin of Shaping Portion

For the IC card or IC tag prepared, the adhesive face between the inlet circuit face and the thermoadhesive layer was carefully peeled. A portion showing interfacial peeling on this peeling face of the thermoadhesive layer was selected, and three-dimensional shape images were obtained in the same manner as (5) above so that the level difference in the indentation of the printed circuit would be included in the visual field. Using the cross-section analytical function of the same software, the cross-sectional shape profile perpendicular to the indentation level difference was obtained. From this profile, the depth of the indentation by the printed circuit was determined, and this was divided by the original height of the printed circuit (10 μm) to obtain the shaping rate. In the outer margin portion of the indentation, the gradient for the level difference between the indentation portion and the non-indentation portion (including the central level difference, gradient at about ⅓ portion of the level difference) was determined, and this was used as the gradient of the outer margin of the shaping portion. Examination was performed on three visual fields, and the mean value for a total of 15 profiles was evaluated.

### (8) Film Coefficient of Static Friction

Measured by the “Cellular plastics—Film and sheeting—Determination of the coefficients of friction” specified in JIS K 7125. The measuring instrument used was a tensile strength tester (manufactured by Shimadzu Corporation, AG1KNI). Ten samples were cut off from five optionally chosen sites of the subject film, and measurements were performed with the top and back faces of the film facing each other. The load exerted on the sliding piece was 1500 g, and the mean value for a total of five runs was obtained as the coefficient of static friction.

### (9) Optical Density and Light Transmittance of Film and Card/Tag

Using a transmission optical densitometer (Macbeth, RD-914), optical density with white light was measured. Measurements were performed on five 50 mm square samples cut out from five optionally chosen sites of the subject sample, and the mean value therefor was converted to light transmittance (%).

### (10) Film Curl Value

The subject film was cut at three optionally chosen portions to obtain sheet-like pieces 100 mm in the longitudinal direction and 50 mm in the lateral direction, and the sheets were thermally treated in an unloaded state at 110° C. for 30 minutes, after which each piece of the film was gently placed on a horizontal glass plate with the convex thereof down, the vertical distance between the glass plate and each of the lower ends of the four corners of the risen piece of the film was measured in a minimum scale of 0.5 mm unit of measurement using a ruler, and the mean value for the measured values for these four sites was used as the curl value. The measurements were performed on three pieces of the film, and the mean value therefor was used as the curl value.

### (11) Ruggedness Absorbability

For the IC card or IC tag prepared, the outer margin of the portion where the antenna circuit or copper foil was arranged was examined using a three-dimensional shape determination apparatus (manufactured by Ryoka Systems Inc., Micromap TYPE550, objective lens ×10) in the WAVE mode. The level difference produced due to the presence or absence of the antenna circuit or copper foil was examined in three visual fields (3 points per visual field), and the mean value was determined. It was judged that as the level difference decreased, the ruggedness absorbability increased; if the level difference was less than 3 μm, the rating ⊙ was given; if the level difference was not less than 3 μm and less than 6 μm, the rating o was given; if the level difference was not less than 6 μm, the rating x was given. If a copper foil is used, although there is no function for an IC card or IC tag, this method can be used as a model evaluation method for the ruggedness absorbability of a card or tag prepared using a thermoadhesive film.

### (12) Film Thermal Adhesiveness

For the IC card or IC tag prepared, peeling was performed by manual operation. Samples showing no thermal adhesion were given the rating x, those showing interfacial peeling over the entire surface were given the rating Δ, those showing cohesive failure in the majority of the area of the thermoadhesive layer were given the rating ∘, and those showing material failure were given the rating ⊙.

### (13) Apparent Density of Film and Card/Tag

Measured on five 100 mm square samples cut out from five optionally chosen portions by the “Cellular plastics and rubbers—Determination of apparent (bulk) density” specified in JIS K 7222. Measurements were performed at room temperature, and the mean value was used as the apparent density. For the sake of expression simplification, the unit of measurement was converted to g/cm³.

### (14) Heat Resistance of IC Card or IC Tag

The IC card or IC tag prepared was gently placed on a clean flat stainless steel plate (SUS304, thickness 0.8 mm), and kept under heating in an air atmosphere using an oven at 120° C. for 24 hours. Sample appearance (loss of gloss, discoloration, cloud, cracking, deformation, melting, fusion) was visually evaluated before and after heating; samples showing no differences between before and after heating were given the rating ∘, and those showing differences were given the rating Δ or x depending on the extent of the difference.

### (15) Intrinsic Viscosity of Polyester Resin

Measured at 30° C. using a phenol/1,1,2,2-tetrachloroethane (60/40; parts by mass) mixed solvent by the “Plastics—Determination of the viscosity of polymers in dilute solution using capillary viscometers” specified in JIS K 7367-5.

### (16) Average Particle Diameter of Particles

Particles were examined using a scanning electron microscope (manufactured by Hitachi, Ltd., S2500); photomicrographs were taken at magnification rates changed according to particle size, and enlarged using a copying machine. Next, for at least 200 randomly selected particles, the outer periphery of each particle was traced. From these traces, the circle-equivalent diameters of the particles were measured using an image analyzer, and the mean value thereof was calculated as the average particle diameter.

### Example 1

### Production of Polyethylene Terephthalate Resin

When the esterification reaction vessel was heated to reach 200° C., a slurry comprising 86.4 parts by mass of terephthalic acid and 64.4 parts by mass of ethylene glycol was charged, and while stirring, 0.017 parts by mass of antimony trioxide as the catalyst and 0.16 parts by mass of triethylamine were added. Next, heating was performed, and a pressurized esterification reaction was carried out under the conditions of 0.34 MPa gauge pressure and 240° C.

Thereafter, the inside pressure of the esterification reaction vessel was returned to normal pressure, and 0.071 parts by mass of magnesium acetate tetrahydrate and then 0.014 parts by mass of trimethyl phosphate were added. Furthermore, after the temperature was raised to 260° C. over 15 minutes, 0.012 parts by mass of trimethyl phosphate and then 0.0036 parts by mass of sodium acetate were added. The esterification reaction product obtained was transferred to a polymerization-condensation reaction vessel, and the temperature was gradually raised from 260° C. to 280° C. under reduced pressure, after which a polymerization-condensation reaction was carried out at 285° C. After completion of the polymerization-condensation reaction, filtration treatment was performed using a filter of sintered stainless steel having a pore diameter of 5 μm (initial filtration efficiency 95%).

Next, in a closed room wherein foreign matter particles having diameters of not less than 1 μm present in the air had been reduced using a HEPA filter, the polyethylene terephthalate (PET) which was the above-described polymerization-condensation reaction product was pelletized. This pelletization was performed by a method comprising extruding the molten PET from the nozzle of the extruder in the cooling water bath while supplying cooling water, previously subjected to filtering treatment (pore diameter: not more than 1 μm), and cutting the strand-like PET resin formed. The PET pellets obtained had a intrinsic viscosity of 0.62 dl/g, an Sb content of 144 ppm, an Mg content of 58 ppm, a P content of 40 ppm, a color L value of 56.2, and a color b value of 1.6, and were substantially devoid of inactive particles and internally precipitated particles.

### Production of Non-Crystalline Polyester Resin

For the above-described PET resin, manufacturing was performed with 15 molar % of the ethylene glycol replaced with neopentylglycol and 15 molar % of the terephthalic acid replaced with isophthalic acid, to yield a non-crystalline polyester resin A1. In an analysis of this resin using a DSC apparatus, no melting point was observed, and the glass transition temperature was 78° C.

For the above-described PET resin, manufacturing was performed with 30 molar % of the ethylene glycol replaced with cyclohexanedimethanol, to yield a non-crystalline polyester resin A2. In an analysis of this resin using a DSC apparatus, no melting point was observed, and the glass transition temperature was 81° C.

### Preparation of Master Pellet Containing Hollow-Forming Agent

20% by mass of a polystyrene resin having a melt flow rate of 1.5 (manufactured by Japan Polystyrene Inc., Nippon Polysty G797N), 20% by mass of a vapor-phase-polymerized polypropylene resin having a melt flow rate of 3.0 (manufactured by Idemitsu Petrochemical, IDEMITSU PP F300SP) and 60% by mass of a polymethylpentene resin having a melt flow rate of 180 (manufactured by Mitsui Chemicals, Inc.: TPX, DX-820) were pellet-mixed, this mixture was fed to a biaxial extruder and thoroughly kneaded, and the strand was cooled and cut to yield master pellets containing a hollow-forming agent.

### Preparation of Master Pellets Containing Titanium Oxide

A mixture of 50% by mass of the polyethylene terephthalate resin obtained above with 50% by mass of an anatase type titanium dioxide having an average particle diameter of 0.3 μm (electron microscope method) (manufactured by Fuji Titanium Industry Co., Ltd., TA-300) was fed to a vent-type biaxial extruder and preliminarily kneaded, after which the molten polymer was continuously fed to a vent-type mono-axial kneading machine and kneaded to yield master pellets containing titanium oxide.

### Preparation of Master Pellets Containing Organic Particles

A mixture of 70% by mass of the polyethylene terephthalate resin obtained above with melamine particles having an average particle diameter of 3.5 μm (catalogue value) (manufactured by Nissan Chemical Industries, Ltd., Optobeads 3500M) [30% by mass] was fed to a vent-type biaxial extruder and preliminarily kneaded, after which the molten polymer was continuously fed to a vent-type mono-axial kneading machine and kneaded to yield master pellets containing organic particles.

### Production of Thermoadhesive Biaxially Stretched Polyester Film

The aforementioned PET resin was used as the raw material M, and a mixture comprising 90% by mass of the above-described non-crystalline polyester resin A1 and 10% by mass of atactic polystyrene resin (manufactured by Japan Polystyrene Inc., G797N; glass transition temperature 78° C.) was used as the raw material C. The raw material M and the raw material C were vacuum-dried to a water content ratio of 80 ppm, and separately fed to different extruders. During the extrusion, to adjust the blendability and lamination stability, the raw material M was heated to 280° C. in the extruder and mixed in a molten state, after which it was fed to a feed block at a resin temperature of 270° C. The raw material C was heated to 250° C. and blended in a molten state in the extruder, after which it was fed to a feed block at a resin temperature of 280° C. These raw materials were joined in a feed block so that the thermoadhesive layer consisting of the raw material C would be laminated on both faces of the intermediate layer (substrate) consisting of the raw material M. This was extruded from a T-dice onto a cooling drum adjusted to 20° C. to yield a non-stretched film of 3-layer configuration having a thickness of 2.4 mm. During production of the non-stretched film, the film was cooled by blowing a cold wind adjusted to 20° C. and a relative humidity of 30% to the opposite face of the cooling drum.

The non-stretched film obtained was uniformly heated to 65° C. using a heat roll of Teflon (registered trademark); furthermore, while heating to obtain a film temperature of 95° C. using four infrared heaters each equipped with a gold reflection membrane at a surface temperature of 700° C., placed to face both faces of the film, the film was stretched 3.4 fold in the longitudinal direction between ceramic rolls by means of the speed difference. The roll diameter in the longitudinal stretching step was 150 mm; using a suction-roll, electrostatic-contact, part-nip contact apparatus, the film was brought into close contact with the roll. After the longitudinally monoaxially stretched film thus obtained was pre-heated with a dry hot air to obtain a film surface temperature of about 100° C. with both ends of the film clipped, the film was stretched 3.8 fold in the lateral direction while heating to about 140° C. Thereafter, with the film width fixed, the film was heated to about 230° C. using an infrared panel heater and dry hot air to achieve thermal fixation, and while cooling to about 200° C., the film was subjected to 5% relaxation heat treatment in the lateral direction. Thereafter, the film was gradually cooled step by step with dry warm air adjusted to 150° C., 100° C. and room temperature, and the film ends were cut off at a film surface temperature (sufficiently lower than the glass transition temperature of the thermoadhesive layer) of under 50° C., to yield a film roll. Thereby, a thermoadhesive polyester film having a thickness of 190 μm was obtained. When cross-sections of the film were examined using a scanning electron microscope, the thicknesses of the layers (thermoadhesive layer Aa/intermediate layer (substrate)/thermoadhesive layer Ab) were approximately 20/150/20 (unit of measurement: μm).

An IC card was produced using the thermoadhesive polyester film obtained by the above-described method, and the card characteristics thereof (thermal adhesiveness, ruggedness absorbability, heat resistance) were evaluated. That is, the film obtained above was cut to obtain two sheet-like pieces of 100 mm×70 mm size, between which an inlet for IC tags (manufactured by OMRON Corporation, V720S-D13P01) was arranged. On both outer faces of each of these two pieces, a transparent biaxially stretched polyester film (manufactured by Toyobo, COSMOSHINE A4300; 188 μm) was superposed, and they were bonded together using a hot press (140° C., 0.3 MPa, 10 minutes). From this lamination, an 86 mm×54 mm piece including the inlet portion was cut out, and the four corners thereof were cut off to yield an IC card. The configuration of the film is shown in Table 1; the characteristics of the film and the card are shown in Table 2; the configuration of the card is shown in FIG. 1.

The thermoadhesive polyester film obtained in this Example 1 is a film reconciling thermal adhesiveness and ruggedness absorbability and sliding quality suitable for core sheets used for IC cards. The heat resistance and flatness were also suitable for IC cards.

### Comparative Example 1

In place of the polystyrene resin added in Example 1 above, a polyethylene terephthalate resin comprising 5000 ppm of amorphous silica particles having an average particle diameter of 1.5 μm was used. In the same manner as Example 1, except for these conditions, a thermoadhesive polyester film and an IC card were obtained. Although the thermoadhesive polyester film obtained in this Comparative Example 1 had thermal adhesiveness and ruggedness absorbability suitable for core sheets used in IC cards, the coefficient of friction could not be determined because of blocking due to extremely poor sliding quality. For this reason, even in the process of producing the IC card, aberrations associated with handlability and thermal expansion could not be modified, and wrinkles and folds occurred.

### Comparative Example 2

In place of the polystyrene resin added in Example 1 above, a polyethylene terephthalate resin comprising 50% by mass of barium sulfate particles having an average particle diameter of 3 μm was used. In the same manner as Example 1, except for these conditions, a thermoadhesive polyester film and an IC card were obtained. Although the thermoadhesive polyester film obtained in this Comparative Example 2 had thermal adhesiveness and ruggedness absorbability suitable for core sheets used in IC cards, the coefficient of friction could not be determined because of blocking due to extremely poor sliding quality. For this reason, even in the process of making the card by way of trials, aberrations associated with handlability and thermal expansion could not be modified, and wrinkles and folds occurred.

### Example 2

A mixture consisting of 6% by mass of the aforementioned master pellets containing a hollow-forming agent, 14% by mass of the aforementioned master pellets containing titanium oxide, and 80% by mass of the aforementioned PET resin was used as the raw material M. A mixture comprising 94% by mass of the non-crystalline polyester resin A1, 5% by mass of the above-described polystyrene resin, and 1% by mass of polyethylene resin (manufactured by Mitsui Chemicals, Inc., Hi-wax NL500) was used as the raw material C. Furthermore, the amount of resin discharged from each extruder was regulated so that the lamination thicknesses of the thermoadhesive layer and the intermediate layer (substrate) would be 30/240/30 (unit of measurement: μm) after biaxial stretching. In the same manner as Example 1, except for these conditions, a thermoadhesive polyester film was obtained. Using a hollow-containing white polyester film (manufactured by Toyobo, Crisper K1212, thickness 188 μm, apparent density 1.1 g/cm³) in place of the biaxially stretched polyester film (A4300), an IC card was obtained. The thermoadhesive polyester film obtained in this Example 2 is a film reconciling thermal adhesiveness and ruggedness absorbability and sliding quality suitable for core sheets used in IC cards. The heat resistance, flatness, hiding quality, and lightness were also suitable for IC card materials. The IC card obtained was excellent in lightness and hiding quality.

### Example 3

A mixture consisting of 8% by mass of the aforementioned master pellets containing a hollow-forming agent, 6% by mass of the aforementioned master pellets containing titanium oxide, and 86% by mass of the aforementioned PET resin was used as the raw material M. The amount of polystyrene resin added in the raw material C was 20% by mass. In the same manner as Example 1, except for these conditions, a thermoadhesive polyester film was obtained. Using a hollow-containing white polyester film (manufactured by Toyobo, Crisper K2323, thickness 188 μm, apparent density 1.1 g/cm³) in place of sandmat-processed biaxially stretched polyester film, an IC card was obtained. The thermoadhesive polyester film obtained in this Example 3 is a film reconciling thermal adhesiveness and ruggedness absorbability and sliding quality suitable for core sheets used in IC cards. The heat resistance, flatness, hiding quality, and lightness were also suitable for IC card materials. The IC card obtained was excellent in lightness and hiding quality.

### Example 4

A mixture consisting of 30% by mass of the master pellets containing titanium oxide and 70% by mass of PET resin was used as the raw material M, and a mixture consisting of 95% by mass of the non-crystalline polyester resin A1 and 5% by mass of polycarbonate resin (manufactured by Idemitsu Petrochemical, glass transition temperature 148° C.) was used as the raw material C. The amount of resin discharged from each extruder was regulated so that the lamination thicknesses of the thermoadhesive layer and the intermediate layer (substrate) would be 14/47/14 (unit of measurement: μm) after biaxial stretching. Using a hollow-containing white polyester film (manufactured by Toyobo, Crisper K2323, thickness 250 μm, apparent density 1.1 g/cm³), an IC card was obtained. In the same manner as Example 1, except for these conditions, a thermoadhesive polyester film having a thickness of 75 μm and an IC card were obtained. The thermoadhesive polyester film obtained in this Example is a film reconciling thermal adhesiveness and ruggedness absorbability and sliding quality suitable for core sheets used in IC cards. The heat resistance and hiding quality were also suitable for IC cards.

### Example 5

A mixture consisting of 30% by mass of the master pellets containing a hollow-forming agent and 70% by mass of PET resin was used as the raw material M. A mixture consisting of 70% by mass of the non-crystalline polyester resin A2 and 30% by mass of copolymerized cyclic olefin resin (manufactured by Mitsui Chemicals, Inc., APL8008T, glass transition temperature 70° C.) was used as the raw material C. Furthermore, using three extruders, a non-stretched film of 3-layer configuration wherein the two faces had different thermoadhesive layer thicknesses was produced. In this operation, the amount of resin discharged from each extruder was regulated so that the thicknesses of the layers (thermoadhesive layer Aa/intermediate layer (substrate)/thermoadhesive layer Ab) would be 26/150/14 (unit of measurement: μm) after biaxial stretching. The thermoadhesive layer A was the surface in contact with the cooling drum. The non-stretched film obtained was stretched in the same manner as Example 1, but the temperature of the infrared heater was finely adjusted to obtain a difference between the top and back faces of the film, and the curl in the longitudinal direction after biaxial stretching was minimized. In the same manner as Example 1, except for these conditions, a thermoadhesive polyester film having a thickness of 190 μm was obtained. Using a hollow-containing white polyester film (manufactured by Toray Industries, E60L, thickness 188 μm, apparent density 0.9 g/cm³) in place of the biaxially stretched polyester film (manufactured by Toyobo, COSMOSHINE A4300), in the same manner as Example 1, an IC card was obtained. The thermoadhesive polyester film obtained in this Example 5 is a film reconciling thermal adhesiveness and ruggedness absorbability and sliding quality suitable for core sheets used in IC cards. The heat resistance and hiding quality were also suitable for IC card materials. Regarding the flatness, a slight longitudinal curl occurred but to the extent that did not interfere with the handlability of the film in practical use.

### Comparative Example 3

The amount of resin discharged from each extruder was regulated so that the lamination thicknesses of the thermoadhesive layer and the intermediate layer (substrate) would be 47/50/3 (unit of measurement: μm) after biaxial stretching. No means was employed for producing a temperature difference between the top and back faces of the film to reduce the curl of the film in heating with the infrared heater in the longitudinal stretching step. In the same manner as Example 5, except for these conditions, a thermoadhesive polyester film was obtained. An inlet was arranged so that the antenna circuit faced the thermoadhesive layer B face, and in the same manner as Example 5, an IC card was produced. In the laminated biaxially stretched polyester film obtained in this Comparative Example 3, both thermal adhesiveness and ruggedness absorbability were insufficient. A curl at a level making it difficult to handle the film occurred. Because the film could not be kept standing on a flat face, the curl value could not be measured. For this reason, even in the step of producing the IC card, the film was difficult to handle, and positioning could not accurately be preformed when the inlet was pasted to the thermoadhesive layer of the thermoadhesive film.

### Example 6

A mixture consisting of 95% by mass of a commercially available non-crystalline polyester resin A3 (manufactured by Toyobo, Vylon 240; glass transition temperature 60° C.) and 5% by mass of a low-density polyethylene resin (manufactured by Idemitsu Petrochemical, glass transition temperature −36° C.) was used as the raw material C. The amount of resin discharged from each extruder was regulated so that the thicknesses of the layers (thermoadhesive layer Aa/intermediate layer (substrate)/thermoadhesive layer Ab) would be 25/250/25 (unit of measurement: μm) after biaxial stretching. In the same manner as Example 1, except for these conditions, a thermoadhesive polyester film having a thickness of 300 μm was obtained.

Using a sandmat-processed polyester film (surface roughness 0.1 μm, thickness 188 μm, apparent density 1.4 g/cm³) in place of the transparent biaxially stretched polyester film (manufactured by Toyobo, COSMOSHINE A4300), an IC tag was produced. The thermoadhesive polyester film obtained in this Example 6 is a film reconciling thermal adhesiveness and ruggedness absorbability and sliding quality suitable for core sheets used in IC tags. The heat resistance and flatness were also suitable for IC tags.

### Comparative Example 4

In the same manner as Example 6, except that the raw material C non-crystalline polyester resin was replaced with PET resin, which is a crystalline polyester resin, a laminated biaxially stretched polyester film was obtained. However, the film did not have thermal adhesiveness, and no IC tag could be produced.

### Comparative Example 5

As the raw material M, the raw material C of Example 5 was used. To adjust the blendability and lamination stability, the raw material M was heated to 250° C. in the extruder and blended in a molten state, after which it was fed to a feed block at a resin temperature of 280° C. The thickness of the non-stretched film was regulated to 0.25 mm. Except for these conditions, in the same manner as Example 5, a non-stretched sheet was obtained. Using this non-stretched sheet in place of the thermoadhesive polyester film, in the same manner as Example 6, an IC tag was produced. The non-stretched sheet obtained in this Comparative Example 5 exhibited good thermal adhesiveness and ruggedness absorbability, but the sliding quality was poor, and the sheet was difficult to handle. In terms of heat resistance as well, the sheet was insufficient to assure reliability for an IC tag.

TABLE 1

| | | | | | | | | intermediate | | | | |
|---|---|---|---|---|---|---|---|---|---|---|---|---|
| | | | | | | | | layer | | | | |
| | thermoadhesive layer | | | | | | | (substrate) | | | | |
| | | | non-crystalline | | | | | hollow- | | | | |
| | | | thermoplastic resin B | | | inorganic | | forming | white | | | |
| | non-crystalline | | | glass | | particles | | agent | pigment | lamination thickness (μm) | | |
| | polyester resin A | | | transition | content | | content | content | content | thermo- | intermediate | thermo- |
| | | Tg | | tempera- | (mass | | (mass | (mass | (mass | adhesive | layer | adhesive |
| | kind | (° C.) | kind | ture (° C.) | %) | kind | %) | %) | %) | layer A | (substrate) | layer B |
| Ex. 1 | non-crystalline | 78 | PS | 97 | 10 | — | — | — | — | 20 | 150 | 20 |
| | polyester resin A1 | | | | | | | | | | | |
| Comp. | non-crystalline | 78 | — | — | — | amorphous | 0.05 | — | — | 20 | 150 | 20 |
| Ex. 1 | polyester resin A1 | | | | | silica | | | | | | |
| Comp. | non-crystalline | 78 | — | — | — | barium | 5 | — | — | 20 | 150 | 20 |
| Ex. 2 | polyester resin A1 | | | | | sulfate | | | | | | |
| Ex. 2 | non-crystalline | 78 | PS | 97 | 5 | — | — | 6 | 7 | 30 | 240 | 30 |
| | polyester resin A1 | | | | | | | | | | | |
| Ex. 3 | non-crystalline | 78 | PS | 97 | 20 | — | — | 8 | 3 | 20 | 150 | 20 |
| | polyester resin A1 | | | | | | | | | | | |
| Ex. 4 | non-crystalline | 78 | PC | 148 | 5 | — | — | — | 15 | 14 | 47 | 14 |
| | polyester resin A1 | | | | | | | | | | | |
| Ex. 5 | non-crystalline | 81 | COC | 70 | 30 | — | — | 15 | — | 26 | 150 | 14 |
| | polyester resin A2 | | | | | | | | | | | |
| Comp. | non-crystalline | 81 | COC | 70 | 30 | — | — | 15 | — | 47 | 50 | 3 |
| Ex. 3 | polyester resin A2 | | | | | | | | | | | |
| Ex. 6 | non-crystalline | 60 | LDPE | −36 | 5 | — | — | — | — | 25 | 250 | 25 |
| | polyester resin A3 | | | | | | | | | | | |
| Comp. | PET resin | 77 | LDPE | −36 | 5 | — | — | — | — | 25 | 250 | 25 |
| Ex. 4 | (crystalline) | | | | | | | | | | | |

| | |
|---|---|
| Comp. | non-oriented sheet prepared from non-crystalline polyester resin A2 |
| Ex. 5 | |

TABLE 2

| | film characteristics | | | | | | | | | | | |
|---|---|---|---|---|---|---|---|---|---|---|---|---|
| | | gradient | | | | | | | | | | |
| | | (%) of | | | | | | | | | | |
| | | outer | | | | | | | | | | |
| | | margin | | | | | film | card or tag characteristics | | | | |
| | shaping | of | coefficient | apparent | light | | thick- | ruggedness | thermal | heat | apparent | light |
| | rate | shaping | of static | density | transmit- | curl | ness | absorb- | adhesive- | resis- | density | transmit- |
| | (%) | portion | friction | (g/cm³) | tance (%) | (mm) | (μm) | ability | ness | tance | (g/cm³) | tance (%) |
| Ex. 1 | 98 | 270 | 0.47 | 1.4 | 86 | 0.4 | 190 | ⊙ | ⊙ | ◯ | 1.6 | 49 |
| Comp. | 103 | 220 | NG | 1.4 | 97 | 0.4 | 190 | ◯ | ⊙ | ◯ | 1.6 | 62 |
| Ex. 1 | | | | | | | | | | | | |
| Comp. | 100 | 190 | NG | 1.4 | 91 | 0.3 | 190 | ◯ | ⊙ | ◯ | 1.6 | 58 |
| Ex. 2 | | | | | | | | | | | | |
| Ex. 2 | 104 | 350 | 0.68 | 1.1 | 4 | 0.6 | 300 | ⊙ | ⊙ | ◯ | 1.2 | <1 |
| Ex. 3 | 99 | 250 | 0.42 | 1.0 | 8 | 0.4 | 190 | ⊙ | ⊙ | ◯ | 1.1 | <1 |
| Ex. 4 | 86 | 160 | 0.22 | 1.4 | 29 | 0.2 | 75 | ◯ | ⊙ | ◯ | 1.5 | <1 |
| Ex. 5 | 100 | 120 | 0.27 | 0.8 | 19 | 3.9 | 150 | ◯ | ◯ | ◯ | 0.9 | <1 |
| Comp. | 39 | 90 | 0.31 | 0.8 | 21 | NG | 100 | X | Δ | Δ | 0.9 | <1 |
| Ex. 3 | | | | | | | | | | | | |
| Ex. 6 | 105 | 320 | 0.35 | 1.4 | 79 | 1.1 | 300 | ⊙ | ◯ | ◯ | 1.6 | 73 |
| Comp. | 25 | 11 | 0.21 | 1.4 | 66 | 0.9 | 300 | — | X | — | — | — |
| Ex. 4 | | | | | | | | | | | | |
| Comp. | 103 | 300 | NG | 1.3 | 98 | 0.4 | 250 | ⊙ | ⊙ | X | 1.5 | 65 |
| Ex. 5 | | | | | | | | | | | | |

### Example 7

A mixture consisting of the aforementioned master pellets containing a hollow-forming agent [8% by mass], the aforementioned master pellets containing titanium oxide [6% by mass], and the aforementioned PET resin [86% by mass] was used as the raw material M. A mixture consisting of the non-crystalline polyester resin A1 [90% by mass] and a linear low-density polyethylene resin (manufactured by Ube Industries, UMERIT 2040F; melting point 116° C., density 0.918 g/cm³) as the thermoplastic resin B incompatible with the aforementioned resin A1 [10% by mass] was used as the raw material C. Furthermore, the amount of resin discharged from each extruder was regulated so that the lamination thicknesses of the thermoadhesive layer and the intermediate layer (substrate) would be 20/150/20 (unit of measurement: μm) after biaxial stretching. In the same manner as Example 1, except for these conditions, a thermoadhesive polyester film was obtained. Using this thermoadhesive polyester film, an IC card was produced, and the suitability (thermal adhesiveness, ruggedness absorbability, heat resistance) was evaluated. Specifically, the film obtained above was cut to obtain two sheet-like pieces 100 mm×70 mm in size, between which an inlet for IC tags (manufactured by OMRON Corporation, V720S-D13P01) was arranged. On both outer faces of each of these two pieces, a hollow-containing white polyester film (manufactured by Toyobo, Crisper K2323; 100 μm) was superposed, and they were pasted together using a hot press (140° C., 0.3 MPa, 10 minutes). From this lamination, an 86 mm×54 mm piece including the inlet portion was cut out, and the four corners were cut down to give an IC card. The configuration of the film is shown in Table 3, and the characteristics of the film and the card are shown in Table 4. The thermoadhesive polyester film obtained in this Example 7 is a film reconciling thermal adhesiveness and ruggedness absorbability and sliding quality suitable for core sheets used in IC cards. The heat resistance, flatness, hiding quality, and lightness were also suitable for IC cards.

### Comparative Example 6

In the same manner as Example 7, except that a polyethylene terephthalate resin comprising 5000 ppm of amorphous silica particles having an average particle diameter of 1.5 μm (SEM method) was used in place of the linear polyethylene resin in Example 7, a thermoadhesive polyester film and an IC card were obtained. Although the thermoadhesive polyester film obtained in this Comparative Example 6 had thermal adhesiveness and ruggedness absorbability suitable for IC cards, the coefficient of friction could not be determined because of blocking due to extremely poor sliding quality. For this reason, even in the process of producing the IC card, aberrations associated with handlability and thermal expansion could not be modified, and wrinkles and folds occurred.

### Comparative Example 7

In Example 7, in the same manner as Example 7, except that a polyethylene terephthalate resin comprising barium sulfate particles having a particle diameter of 3 μm (SEM method) [50% by mass] was used in place of the linear polyethylene resin in Example 7, a thermoadhesive polyester film and an IC card was obtained. Although the thermoadhesive polyester film obtained in this Comparative Example 7 had thermal adhesiveness and ruggedness absorbability suitable for materials of an IC card, the coefficient of friction could not be determined because of blocking due to extremely poor sliding quality. For this reason, even in the process of producing the IC card, aberrations associated with handlability and thermal expansion could not be modified, and wrinkles and folds occurred.

### Comparative Example 8

In Example 7, in the same manner as Example 7, except that PET resin [100% by mass] was used as the raw material M, and that a mixture consisting of the non-crystalline polyester resin A [60% by mass] and a linear low-density polyethylene resin [40% by mass] was used as the raw material C, a laminated biaxially stretched polyester film and an IC card were obtained. In the laminated biaxially stretched polyester film obtained in this Comparative Example 8, the thermal adhesiveness needed for IC cards was insufficient, and was inappropriate for the intended use.

### Example 8

In Example 7, a mixture consisting of the master pellets containing a hollow-forming agent [6% by mass], the master pellets containing titanium oxide [20% by mass], and the aforementioned PET resin [74% by mass] was used as the raw material M. A mixture consisting of the non-crystalline polyester resin A2 [69% by mass], master pellets containing organic particles [30% by mass], and polyethylene resin (manufactured by Mitsui Chemicals, Inc., Hi-wax 400P) [1% by mass] was used as the raw material C. In the same manner as Example 7, except for these conditions, a thermoadhesive polyester film and an IC card were obtained. The thermoadhesive polyester film obtained in this Example 8 is a film reconciling thermal adhesiveness and ruggedness absorbability and sliding quality suitable for core sheets used in IC cards. The heat resistance, flatness, hiding quality, and lightness were also suitable for IC cards.

### Example 9

In Example 7, a mixture consisting of the master pellets containing a hollow-forming agent [15% by mass] and PET resin [85% by mass] was used as the raw material M. A mixture consisting of the non-crystalline polyester resin A2 [85% by mass] and a high-density polyethylene resin (manufactured by Idemitsu Petrochemical, IDEMITSU HD 640UF; melting point 131° C., density 0.95 g/cm³) [15% by mass] was used as the raw material C. Furthermore, using three extruders, a non-stretched film of 3-layer configuration having a total thickness of 2.1 mm wherein the two faces had different thermoadhesive layer thicknesses was produced. In this operation, the amount of resin discharged from each extruder was regulated so that the thicknesses of the layers (thermoadhesive layer a/intermediate layer (substrate)/thermoadhesive layer b) would be 13/230/7 (unit of measurement: μm) after biaxial stretching. The thermoadhesive layer A was the surface in contact with the cooling drum. The non-stretched film obtained was stretched in the same manner as Example 7, but the temperature of the infrared heater was finely adjusted to obtain a difference between the top and back faces of the film, and the curl in the longitudinal direction after biaxial stretching was minimized. In the same manner as Example 7, except for these conditions, a thermoadhesive polyester film having a thickness of 250 μm and an IC card were obtained. The thermoadhesive polyester film obtained in this Example 9 is a film reconciling thermal adhesiveness and ruggedness absorbability and sliding quality suitable for core sheets used in IC cards. The heat resistance, hiding quality, and lightness were also suitable for IC cards. Regarding the flatness of the film, a slight longitudinal curl occurred but to the extent that did not interfere with the handling of the film in practical use.

### Comparative Example 9

In Example 9, the amount of resin discharged from each extruder was regulated so that the lamination thicknesses of the thermoadhesive layer a/intermediate layer (substrate)/thermoadhesive layer b would be 37/5/3 (unit of measurement: μm) after biaxial stretching. No means was employed for producing a temperature difference between the top and back faces of the film to reduce the curl of the film in heating with the infrared heater in the longitudinal stretching step. In the same manner as Example 9, except for these conditions, a thermoadhesive polyester film was obtained. An inlet was arranged on the thermoadhesive layer b face of this film so that the antenna circuit faced the same, and in the same manner as Example 7, an IC card was produced. In the thermoadhesive polyester film obtained in this Comparative Example 9, both the thermal adhesiveness and ruggedness absorbability were insufficient. A curl at a level making it difficult to handle the film was produced. Because the film could not be kept standing on a flat face, the curl value could not be measured. For this reason, even in the step of producing an IC card, the film was difficult to handle, and positioning could not accurately be preformed when the inlet was pasted to the thermoadhesive layer of the thermoadhesive film.

### Example 10

In Example 9, a mixture consisting of the master pellets containing titanium oxide [30% by mass] and PET resin [70% by mass] was used as the raw material M. Using a mixture consisting of a commercially available non-crystalline polyester resin A3 (manufactured by Toyobo, Vylon 240; glass transition temperature 60° C.) “95% by mass” and a vapor phase method polypropylene resin (manufactured by Idemitsu Petrochemical, IDEMITSU PP F300SP; melting point 160° C., density 0.90 g/cm³) [5% by mass] as the raw material C, a non-stretched film consisting of a 3-layer configuration having a total thickness of 1.3 mm was produced. In this operation, the amount of resin discharged from each extruder was regulated so that the thicknesses of the layers (thermoadhesive layer a/white polyester layer (substrate)/thermoadhesive layer b) would be 14/72/14 (unit of measurement: μm) after biaxial stretching. In the same manner as Example 7, except for these conditions, a thermoadhesive polyester film having a thickness of 100 μm and an IC card were obtained. The thermoadhesive polyester film obtained in this Example 10 is a film reconciling thermal adhesiveness and ruggedness absorbability and sliding quality suitable for core sheets used in IC cards. The heat resistance, hiding quality, and flatness were also suitable for IC cards.

### Example 11

In Example 10, a mixture consisting of the non-crystalline polyester resin A3 [90% by mass] and a polybutadiene resin (manufactured by Nippon Zeon Co., Ltd., Nipol BR1220; melting point 95° C., density 0.90 g/cm³) [10% by mass] was used as the raw material C. In the same manner as Example 10, except for these conditions, a thermoadhesive polyester film and an IC card were obtained. The thermoadhesive polyester film obtained in this Example 11 is a film reconciling thermal adhesiveness and ruggedness absorbability and sliding quality suitable for core sheets used in IC cards. The heat resistance, flatness, hiding quality, and lightness were also suitable for IC cards.

### Comparative Example 10

In Example 10, a mixture consisting of the non-crystalline polyester resin A3 [90% by mass] and a polymethylpentene resin (manufactured by Mitsui Chemicals, Inc., TPX DX820; melting point 234° C., density 0.82 g/cm³) [10% by mass] was used as the raw material C. In the same manner as Example 10, except for these conditions, a laminated biaxially stretched white polyester film and an IC card were obtained. The laminated biaxially stretched white polyester film obtained in this Comparative Example 10 were insufficient in the thermal adhesiveness needed for core sheets used in IC cards, and was inappropriate for the intended use.

### Comparative Example 11

In Example 10, in the same manner as Example 10, except that the raw material C non-crystalline polyester resin A was replaced with PET resin, which is a crystalline polyester resin, a laminated biaxially stretched white polyester film and an IC card were obtained. The laminated biaxially stretched white polyester film obtained in this Comparative Example 11 was insufficient in the thermal adhesiveness and ruggedness absorbability needed for core sheets used in IC cards, and was inappropriate for the intended use.

TABLE 3

| | thermoadhesive layer | | | | | | | substrate (white | | | | |
|---|---|---|---|---|---|---|---|---|---|---|---|---|
| | non-crystalline | | | | | | | polyester layer) | | | | |
| | polyester resin A | | low melting point | | | | | hollow- | | lamination thickness (μm) | | |
| | | glass | thermoplastic resin | | | | | forming | white | | inter- | |
| | | transition | | melting | | particles | | agent | pigment | thermo- | mediate | thermo- |
| | | temperature | | point | content | | content | content | content | adhesive | layer | adhesive |
| | kind | (° C.) | kind | (° C.) | (mass %) | kind | (mass %) | (mass %) | (mass %) | layer a | (substrate) | layer b |
| Ex. 7 | A1 | 78 | LLDPE | 116 | 10 | — | — | 8 | 3 | 20 | 150 | 20 |
| Comp. | A1 | 78 | — | — | — | amorphous | 0.05 | 8 | 3 | 20 | 150 | 20 |
| Ex. 6 | | | | | | silica | | | | | | |
| Comp. | A1 | 78 | — | — | — | barium | 5 | 8 | 3 | 20 | 150 | 20 |
| Ex. 7 | | | | | | sulfate | | | | | | |
| Comp. | A1 | 78 | LLDPE | 116 | 40 | — | — | — | — | 20 | 150 | 20 |
| Ex. 8 | | | | | | | | | | | | |
| Ex. 8 | A2 | 81 | HDPE | 130 | 1 | melamine | 9 | 6 | 10 | 20 | 150 | 20 |
| Ex. 9 | A2 | 81 | HDPE | 127 | 15 | — | — | 15 | — | 13 | 230 | 7 |
| Comp. | A2 | 81 | HDPE | 127 | 15 | — | — | 15 | — | 37 | 5 | 3 |
| Ex. 9 | | | | | | | | | | | | |
| Ex. 10 | A3 | 60 | PP | 162 | 5 | — | — | — | 15 | 14 | 72 | 14 |
| Ex. 11 | A3 | 60 | PBR | 95 | 10 | — | — | — | 15 | 14 | 72 | 14 |
| Comp. | A3 | 60 | PMP | 234 | 10 | — | — | — | 15 | 14 | 72 | 14 |
| Ex. 10 | | | | | | | | | | | | |
| Comp. | — | 77 | PP | 162 | 5 | — | — | — | 15 | 14 | 72 | 14 |
| Ex. 11 | (PET | | | | | | | | | | | |
| | resin) | | | | | | | | | | | |

| | |
|---|---|
| Comp. | non-oriented sheet prepared from non-crystalline polyester resin A2 |
| Ex. 5 | |

TABLE 4

| | surface characteristics | | | | | film characteristics | | | | card characteristics | | |
|---|---|---|---|---|---|---|---|---|---|---|---|---|
| | | | | | coefficient | apparent | | film | | ruggedness | thermal | |
| | | | | | of static | density | optical | thickness | curl | absorb- | adhesive- | heat |
| | St1 (μm) | Sa1 (μm) | St1/Sa1 | St2 (μm) | friction | (g/cm³) | density | (μm) | (mm) | ability | ness | resistance |
| Ex. 7 | 1.77 | 0.19 | 9.32 | 0.21 | 0.48 | 1.1 | 1.1 | 190 | 0.3 | ⊙ | ⊙ | ◯ |
| Comp. | 0.81 | 0.10 | 8.10 | 0.20 | NG | 1.1 | 1.0 | 190 | 0.2 | ⊙ | ⊙ | ◯ |
| Ex. 6 | | | | | | | | | | | | |
| Comp. | 0.98 | 0.13 | 7.54 | 0.31 | NG | 1.1 | 1.3 | 190 | 0.2 | ⊙ | ⊙ | ◯ |
| Ex. 7 | | | | | | | | | | | | |
| Comp. | 26.4 | 3.0 | 8.86 | 13 | 0.29 | 1.4 | 0.2 | 190 | 0.3 | ◯ | Δ | ◯ |
| Ex. 8 | | | | | | | | | | | | |
| Ex. 8 | 3.40 | 0.37 | 9.19 | 1.0 | 0.70 | 1.2 | 1.3 | 190 | 0.3 | ⊙ | ⊙ | ◯ |
| Ex. 9 | 3.53 | 0.40 | 8.89 | 0.26 | 0.35 | 0.9 | 1.2 | 250 | 4.6 | ◯ | ◯ | ◯ |
| Comp. | 2.98 | 0.39 | 7.64 | 0.39 | 0.39 | 1.0 | 0.4 | 45 | NG | X | Δ | Δ |
| Ex. 9 | | | | | | | | | | | | |
| Ex. 10 | 1.21 | 0.13 | 9.31 | 0.45 | 0.57 | 1.4 | 0.8 | 100 | 0.5 | ◯ | ◯ | ◯ |
| Ex. 11 | 1.56 | 0.20 | 7.80 | 0.40 | 0.53 | 1.4 | 0.9 | 100 | 0.4 | ⊙ | ⊙ | ◯ |
| Comp. | 2.25 | 0.28 | 8.04 | 1.50 | 0.51 | 1.4 | 0.8 | 100 | 0.5 | — | X | — |
| Ex. 10 | | | | | | | | | | | | |
| Comp. | 5.07 | 0.20 | 25.35 | 4.38 | 0.31 | 1.4 | 0.8 | 100 | 0.2 | — | X | — |
| Ex. 11 | | | | | | | | | | | | |
| Comp. | — | — | — | — | — | — | — | 250 | — | ⊙ | ⊙ | X |
| Ex. 5 | | | | | | | | | | | | |

### INDUSTRIAL APPLICABILITY

The thermoadhesive polyester film of the present invention reconciles thermal adhesiveness and ruggedness absorbability and sliding quality, which reconciliation has been difficult to achieve in biaxially stretched polyester films having excellent heat resistance, chemical resistance, and environmental suitability. Thereby, the above-described characteristics that have not been achieved with non-oriented PVC sheets, PETG sheets, biaxially stretched polyester films, or combinations thereof pasted together, used in conventional IC cards or IC tags, can be accomplished. The present invention will significantly contribute not only to the improvement in the performance of IC cards or IC tags, but also to an economic effect of the obviation of the pasting step.

1. A thermoadhesive polyester film wherein a thermoadhesive layer is laminated on one face or both faces of a biaxially stretched polyester film, the thermoadhesive layer having a thickness of 5 to 30 μm, consisting of a mixture of a non-crystalline polyester resin A having a glass transition temperature of 50 to 95° C. and a thermoplastic resin B incompatible therewith, the thermoplastic resin B being any of (a) a crystalline resin having a melting point of 50 to 180° C., (b) a non-crystalline resin having a glass transition temperature of −50 to 150° C., and (c) a mixture thereof, and contained at 1 to 30% by mass in the thermoadhesive layer.

2. The thermoadhesive polyester film of claim 1, wherein the biaxially stretched polyester film is a white polyester film comprising one or both of a white pigment and fine hollows therein.

3. The thermoadhesive polyester film of claim 1, wherein a thermoadhesive layer is laminated on both faces of the biaxially stretched polyester film, one thermoadhesive layer is designated as the thermoadhesive layer a, and the other designated as the thermoadhesive layer b (as thick as the thermoadhesive layer a or thinner than the thermoadhesive layer a), the ratio of the thicknesses of the thermoadhesive layers (thickness of the thermoadhesive layer a/thickness of the thermoadhesive layer b) is 1.0 to 2.0, and the curl value after heat treatment of the film (110° C., non-loaded, for 30 minutes) is not more than 5 mm.

4. The thermoadhesive polyester film of claim 1, wherein a large number of fine hollows are present in the film, (a) the apparent density of the film is 0.7 to 1.3 g/cm³, (b) the thickness is 50 to 350 μm, (c) and the optical density is 0.5 to 3.0 or the light transmittance is 25 to 98%.

5. The thermoadhesive polyester film of claim 1, wherein the surface of the thermoadhesive layer satisfies the following formulas (1) to (3):
1.0≦St1≦10.0 (1)
3.0≦St1/Sa1≦20 (2)
0.001≦St2≦3.000 (3)
wherein Sa1 means the arithmetic mean surface roughness of the thermoadhesive layer surface, St1 means the maximum height, St2 means the arithmetic mean surface roughness of the surface of the thermoadhesive layer after the film is sandwiched between two clean glass plates having an arithmetic mean surface roughness of not more than 0.001 μm, and subjected to hot press treatment at a temperature of 100° C. and a pressure of 1 MPa for 1 minute, and for all of Sa1, St1, and St2, the unit of measurement is μm.

6. The thermoadhesive polyester film of claim 1, wherein the coefficient of static friction between the top surface and back face of the thermoadhesive polyester film is 0.1 to 0.8, and the shaping quality by hot pressing satisfies (4) and (5):
(4) shaping rate: 40 to 105%
(5) gradient of outer margin of shaping portion: 20 to 1000%
wherein the shaping rate refers to the depth of the depression in the thermoadhesive layer caused by an antenna circuit or a copper foil piece, when it is placed on the surface of the thermoadhesive layer, hot pressed and removed at normal temperature and normal pressure; the gradient of the outer margin of the shaping portion refers to the gradient of the wall face in the outer margin of this depression.

7. A method of producing IC cards or IC tags, comprising using a core sheet prepared by arranging the thermoadhesive film of claim 1 on one face or both faces of an inlet provided with an antenna circuit and an IC chip, and pasting the inlet to a plastic film by hot pressing via the thermoadhesive layer of the thermoadhesive film, as a constituent thereof.

8. An IC card or IC tag comprising a core sheet prepared by laminating the thermoadhesive film of claim 1 on one face or both faces of an inlet provided with an antenna circuit and an IC chip, and pasting the inlet to a plastic film via the thermoadhesive layer of the thermoadhesive film, as a constituent thereof.

9. The IC card or IC tag of claim 8, wherein a polyester sheet or a biaxially stretched polyester film is laminated on both faces of the core sheet.

10. The IC card or IC tag of claim 8, wherein the apparent density is not less than 0.7 g/cm³ and less than 1.3 g/cm³.

11. The IC card or IC tag of claim 8, wherein the light transmittance is not less than 10% and not more than 98%.

12. The IC card or IC tag of claim 8, wherein the light transmittance is not less than 0.01% and not more than 5%.

13. The thermoadhesive polyester film of claim 2, wherein a large number of fine hollows are present in the film, (a) the apparent density of the film is 0.7 to 1.3 g/cm³, (b) the thickness is 50 to 350 μm, (c) and the optical density is 0.5 to 3.0 or the light transmittance is 25 to 98%.

14. The IC card or IC tag of claim 9, wherein the apparent density is not less than 0.7 g/cm³ and less than 1.3 g/cm³.

15. The IC card or IC tag of claim 9, wherein the light transmittance is not less than 10% and not more than 98%.

16. The IC card or IC tag of claim 9, wherein the light transmittance is not less than 0.01% and not more than 5%.
